(19) United States
(12) Patent Application Publication
(10) Pub. No.: US 2002/0161659 A1
(43) Pub. Date: Oct. 31, 2002

(54) Color image display accuracy for display devices on a network

(76) Inventors: David P. Veilleux, Stillwater, MN (US); Christopher J. Edge, St. Paul, MN (US)

Correspondence Address: Attention: William D. Bauer, Imation Corp., Legal Affairs, P.O. Box 64898, St. Paul, MN, 55164-0898, US

(21) Appl. No.: 09/808,851

(22) Filed: Mar. 15, 2001

(51) Int. Cl. G06F 17/60

(52) U.S. Cl. 705/26

(57) ABSTRACT

Improved color image display accuracy can be achieved across a computer network by obtaining information characterizing the color response of display devices associated with a client residing on the computer network, and using the information to modify color images delivered to the client. Display accuracy can be achieved in a network having multiple clients that submit images and multiple clients that receive images, such as in the case of an online auction or photo web site. The information can be obtained, for example, by guiding source clients who upload images and destination clients who download images through a color profiling process that profiles the color response of the display device. For example, such guidance may take the form of a series of instructional web pages that are delivered to the client. The web pages can be made interactive to enable collection of color characterization data from the client.

### TECHNICAL FIELD

The invention relates to color imaging and, more particularly, to presentation of color images on display devices.

### BACKGROUND

The growth of the Internet has created sizable opportunities for online retailers and other product marketers. Most major retailers of consumer products have established commercial sites on the World Wide Web. At the same time, the availability of web site presence has eliminated many of the marketing barriers previously experienced by smaller retailers. Online auctions also have been a popular mode of commerce for small retailers and individual web users alike. Virtually any retailer can now post product information for easy access by potential customers, and take orders for its products in an automated fashion.

The product information may include a large number of images. The images enable web customers situated at client devices to view products before submitting an online purchase order. For some items, the user is permitted to click on a “thumbnail” image to view the item in a higher resolution format. In many cases, however, the quality of the images can be a significant concern. Color accuracy, in particular, can be very important for products for which color is a major selling point.

In the case of clothing retailers, for example, an image of a sweater should match its actual color as closely as possible. Unfortunately, the color output characteristics of different display devices can differ significantly. A cathode ray tube (CRT) or flat panel display, video card, driver software, and operating system together determine how red, green, and blue (RGB) pixel values will be rendered and displayed, and vary significantly from system to system.

Consequently, an online customer may order what appears to be a burgundy sweater but instead receive a bright red sweater. Indeed, color inaccuracy has become a significant cause for return of merchandise purchased by online customers. In addition, customer dissatisfaction may prevent return visits to the retailer's web site. In some cases, this problem can erase the advantages obtained by a seller's commitment to online merchandising, and undermine continued investment.

At the same time, color accuracy has become important for exchange of imagery by non-retail entities. Photography enthusiasts have embraced both emerging digital photography opportunities and web sites that promote fulfullment and sharing of photographic imagery. With inevitable comparisons to conventional photography, digital photographers have come to demand increased color accuracy.

### SUMMARY

The invention relates to improvement of color image display accuracy in a computer network having display devices with different color output characteristics. In particular, the invention may be useful for color image display accuracy in a network having multiple clients that submit images and multiple clients that receive images.

Color accuracy can be difficult to obtain in an environment in which several clients upload images to an intermediate server and several clients download the images from the server. In this situation, the display devices associated with the various uploading clients and downloading clients may have very different calorimetric characteristics.

Thus, some embodiments of the invention may be especially useful for processes involving color accuracy issues at two ends of an image transfer process. In an online auction or photography web site, for example, display device differences can cause color image accuracy problems among both the source clients submitting images and the destination clients receiving images. Auction and photography web sites are examples of environments in which color concerns can arise at both the source and destination ends of the process.

Online auctions, as an example, present image color accuracy concerns. With auction sellers posting items ranging from glassware to artwork, the availability of accurate representative images of the items has become a significant selling point. As with retail sites, however, the color accuracy of those images can be undermined by differences between the buyers' display systems. Moreover, the accuracy problems can be compounded by differences between the various sellers' display and image capture systems. For an online auction, unlike a retail site, the images do not originate from a single source, but rather from thousands of generally anonymous sellers.

Online photo sharing and fulfillment sites raise similar image color accuracy issues. Amateur photographers, for example, who post photos to the web site for viewing by family and friends, have different display and image capture systems. At the same time, the display devices used by family and friends to access the photos can be markedly different. Accordingly, the colors viewed by the photographer and the family and friends may differ substantially. Although less critical, color accuracy in the amateur photo context is highly desirable, especially for web sites that permit online photo appearance editing by the source client. In general, online photography sharing sites and online auction sites present examples of a two-way calibration problem in which display characteristics can differ substantially both at the image input and image output ends.

In contrast to most retail sites, in which a single retailer has control over the posted images, an auction or photography site receives images from a number of different sources with little if any information about the colorimetric characteristics of the image or the client. This compounds the problem of color accuracy, even though color can be just as critical for buying decisions on an auction site, and very important for the sharing of photos.

In one embodiment, the invention provides a method that involves receiving color images from source clients via a computer network and communicating the color images to destination clients via the computer network. The color images are modified based on the colorimetric responses of display devices associated with the source clients.

In another embodiment, the invention provides a computer readable medium containing program code that causes a programmable processor to receive color images from source clients via a computer network, communicate the color images to destination clients via the computer network, and modify the color images based on the colorimetric responses of display devices associated with the source clients.

In an added embodiment, the invention provides a system comprising a network server and a color image server. The network server receives color images from source clients and communicates the color images to destination clients. The color image server modifies the color images based on the colorimetric responses of display devices associated with the source clients.

In some embodiments, the color images are modified based on the calorimetric responses of display devices associated with only the source clients. In other embodiments, the color images are modified based on the calorimetric responses of display devices associated with both the source clients and the destination clients. In either case, the color images may be modified based on the source client characteristics to produce an intermediate image in a standard color condition. When a destination client requests an image, the image may be modified from the standard color condition based on the calorimetric characteristics of the destination client.

The invention, in particular embodiments, may provide a number of advantages. The invention can provide calorimetric characterization of display devices associated with source clients that upload images to an intermediate server and destination clients that download the images. A color profiling server can be provided to guide the various clients through a color profiling process. Information obtained for each client from the color profiling process can be uploaded to a color correction server and used to modify the color of images downloaded to destination clients, such as friends and family viewing photos or auction bidders. Thus, the invention provides two-way calibration via an intermediate server that facilitates accurate and consistent color display for the source and destination clients. In some embodiments, color conversion may occur at a color server or at a destination client.

The details of one or more embodiments of the present invention are set forth in the accompanying drawings and the description below. Other features, objects, and advantages of the present invention will be apparent from the description and drawings, and from the claims.

### BRIEF DESCRIPTION OF THE DRAWINGS

FIG. 1 is a block diagram of a system for improving color image display accuracy between source and destination clients in a computer network;

FIG. 2 is a block diagram of a web-based environment incorporating a system as shown in FIG. 1;

FIG. 3 is a flow diagram illustrating a color profiling process for a display device associated with a source client;

FIG. 4 is a flow diagram illustrating a color profiling process for a display device associated with a destination client;

FIG. 5 is a flow diagram illustrating a process for modifying color images for improved color accuracy;

FIG. 6 is a flow diagram illustrating a color profiling process in greater detail;

FIG. 7 is a block diagram illustrating a color correction scheme for images uploaded from multiple source clients and downloaded to multiple destination clients;

FIG. 8 is a flow diagram illustrating a process for calculating a color correction fee;

FIG. 9 is a flow diagram illustrating another process for calculating a color correction fee;

FIG. 10 is a flow diagram illustrating another process for calculating a color correction fee;

FIG. 11 is a flow diagram illustrating a process for improving color image display accuracy in greater detail;

FIG. 12 is a flow diagram illustrating a multi-channel black point determination in a color profiling process;

FIG. 13 is a diagram of a web page for analog adjustment of a color display prior to black point determination;

FIG. 14 is a diagram of a web page for determination of black point for a particular color channel;

FIG. 15 is a flow diagram illustrating gamma and gray balance determination in a color profiling process;

FIG. 16 illustrates a range of gray elements for use in determining a coarse gamma in a color profiling process;

FIG. 17 illustrates a range of gray elements for use in determining a fine gamma in a color profiling process;

FIG. 18 illustrates a range of gray elements for use in determining gray balance in a color profiling process;

FIG. 19 is a block diagram illustrating transmission of color correction information in a system as shown in FIGS. 1 and 2.

### DETAILED DESCRIPTION

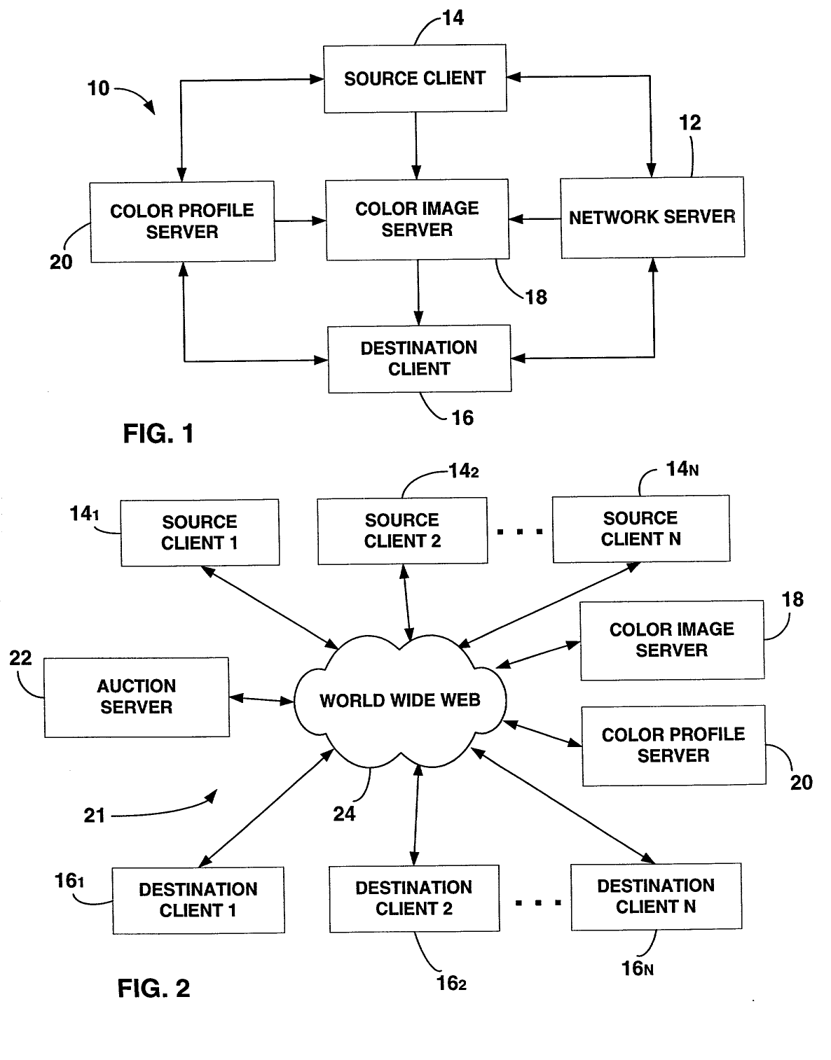

FIG. 1 is a block diagram of a system 10 for improving color image display accuracy across a computer network. The computer network may take the form of a local area network, wide area network, or global computer network such as the World Wide Web. As shown in FIG. 1, system 10 may include a network server 12, a source client 14, a destination client 16, a color image server 18, and a color profile server 20.

Network server 12 may be a web server, and provides destination source and destination clients 14 with access to web pages incorporating graphic content such as color images. Some of the color images incorporated in the web pages can be stored at network server 12 while other color images can be stored at color image server 18 and referenced by tags embedded in the web pages.

Some of the images may be uploaded to network server 12 and/or color image server 18 by source client 14. Network server 12 may store lower resolution color images as well as images that are less color-intensive. Higher resolution color images and more color-intensive images can be stored at color image server 18. Source client 14 may be one of many source clients who upload color images to network server 12, color image server 18, or both. The color images may be uploaded, for example, as part of an online auction process in which the source client is the seller of an auction item.

The images are downloaded by destination client 16, which may be one of many destination clients that download images and web pages from network server 12 and images from color image server 18. As an example, destination clients 16 may be clients who bid on an auction item posted by one of the source clients. In this case, a color image of the item may be important as a selling point, e.g., in demonstrating that the item has particular qualities or color characteristics. A well known example of an online auction site on the World Wide Web is www.ebay.com..

As another example, the source client could be an amateur or professional photographer who uploads digital color photos for storage, printing, and sharing with others. In the case of an amateur photographer, the digital photos may be posted by source client 14 for viewing by friends and family, illustrated as destination clients 16. Photos posted by a professional photographer may be provided for viewing by customers. The photos may originate from a digital camera or a digital scan of a conventional photograph. Examples of commercial photo sites on the web are ofoto.com and shutterfly.com.

In each of the above examples, there are potentially a large number of source clients 14 uploading color images and destination clients 16 seeking to download and view the images. Unfortunately, the display devices used by the source clients and the destination clients may vary widely in calorimetric response. Accordingly, a color image that appears satisfactory when displayed on the display device of a source client 14 may appear less than satisfactory when displayed on any of the display devices associated with the destination clients. The discrepancy is due not only to colorimetric differences on the destination side, but also colorimetric differences for each of the images at the source side. In many cases, source clients 14 may also serve as destination clients 16 and vice versa.

In accordance with an embodiment of the invention, the color images are modified based on the colorimetric responses of the display devices associated with the source client 14 that uploaded the image and a destination client 16 that requested a download of the image. In this manner, the calorimetric differences can be compensated at both ends of the process, thereby providing greater accuracy. To obtain the necessary colorimetric response information, the invention may involve execution of a color profiling process for each of the source and destination clients. In addition to the auction site and photo site examples, the invention may be useful in a variety of processes involving two-way transfer of images via a network server from many source clients at one end and many destination clients at the other end.

With further reference to FIG. 1, color profile server 20 may administer color profiling processes for source and destination clients 14, 16. Once the color profiling process is complete, color profile server 20 generates information characterizing the calorimetric response of the display devices associated with source and destination clients 14, 16. The information for each client 14, 16 can be transmitted to color image server 18 by color profile server 20. In one embodiment, the information for each client 14, 16 is stored in a color profile cookie that is downloaded to the respective client.

Source client 14 initially interacts with network server 12 to communicate information concerning an image or set of images to be uploaded, e.g., for an online auction or photo site. Source client 14 may upload the image to network server 12 or color image server 18. In one embodiment, source client 14 uploads the image to color image server 18 and network server 12 stores a web page that references the uploaded image. On the first attempt to upload an image, source client 14 may be redirected to color profile server 20 to complete a color profiling process for acquisition of colorimetric response information.

When a source client 14 seeks to upload an image, color image server 18 first determines whether source client 14 has uploaded a color profiling cookie. If so, it generally is not necessary to repeat the color profiling process. The cookie may contain parametric information characterizing the calorimetric response of the source client display device can be added to the cookie. In this case, color image server 18 extracts the contents of the cookie and prepares a color profile for the source client, i.e., a source profile. Alternatively, the color profile may be precomputed by color profile server 20 and then added to the source profile cookie at the end of the color profiling process.

The parametric information or precomputed color profile may include information pertaining to estimated blackpoint, gamma, and gray balance. The resulting source profile can be preserved in a database accessible by color image server 18 and associated with the pertinent image uploaded by source client 14. Alternatively, the source profile can be embedded, attached, or otherwise included with the pertinent image file. In either case, the source profile is readily accessible by color image server 18 for the purpose of rendering the necessary color modifications.

When a destination client seeks to download a color image for the first time, a similar color profiling process can be completed. If a web page accessed by destination client 16 via network server includes an image stored on color image server 18, the destination client interacts with the color image server. If color image server 18 does not detect a destination profile cookie from destination client 16, the destination client is redirected to color profile server 20. Color profile server 20 then completes the color profiling process, which may be substantially similar to the color profiling process for source client 14.

After completing the color profiling process, the color profile server 20 adds the calorimetric response parameters to a destination profile cookie and downloads it to destination client 16. Alternatively, color profile server 20 may generate a destination profile and incorporate it in the cookie. Thereafter, when a web page is requested from network server 12 and the page includes a color image residing on color image server 18, destination client 16 uploads the cookie to the color image server 18. Color image server 18 extracts the colorimetric response information from the destination profile cookie.

Color image server 18 then retrieves the requested image and the pertinent source profile. Using the pertinent source and destination profiles, color image server 18 generates a modification to the color image. In some embodiments, color image server 18 may initially use the source profile to convert the image to a standard color setting, and then convert the standard color image based on the destination profile at a later time when a particular destination client 16 requests access to the image. The modification alters the color values of the color image file to compensate for the differences in colorimetric response between the display device associated with source client 14 and the display device associated with destination client 16. In this manner, the color of the image displayed by destination client 16 more accurately matches the color of the image as originally displayed by source client 14. In some embodiments, color conversion may occur at destination client 16, e.g., by downloading a standard image and a color conversion table to the destination client.

Network server 12, client 14, color image server 18, and color profile server 20 each execute program code stored on computer-readable media residing either locally with the respective device or executed remotely. For client 14, for example, the program code may reside in random access memory (RAM) that is accessed and executed by the client computer. The program code can be loaded into the memory from another memory device, such as a fixed hard drive or removable media device associated with client 14.

The program code can be initially carried on computer-readable media, for example, such as magnetic, optical, magneto-optic or other disk or tape media, or electronic media such as EEPROM. Alternatively, the program code can be loaded into the medium by transmission from a remote data archive, e.g., via a local area network, wide area network, or global network such as the Internet. A substantial portion of the code may be web page code that is transmitted to the respective device and executed by a server or browser application.

Web page code, e.g., Hypertext Markup Language (HTML), Extensible Markup Language (XML), or the like, generated by network server 12 may include image tags that point to specific color images stored at color image server 18 or elsewhere. When client 14 accesses a particular web page delivered by network server 12 and executes the HTML to assemble the page content, color image server 18 is accessed to obtain any images tagged within the web page code. Thus, the content of a web page assembled for client 14 may include objects obtained from different resources within the network occupied by system 10, such as network server 12 and color image server 18.

In some embodiments, network server 12 and color image server 18 may be integrated with one another. In the example of FIG. 1, however, color image server 18 and network server 12 are separate entities. Network server 12 and color image server 18 each may interact with a database server and file server to obtain access to selected color images for delivery to client 14. Moreover, in operation, network server 12 may be realized by one of several network servers that access one or more common file and database servers.

Clients 14, 16 may take the form of a variety of devices that permit a user to access resources on system 10 and display color images obtained from such resources. Examples of clients 14, 16 include desktop or portable computers operating in a Windows, Macintosh, Unix, or Linux environment, personal digital assistants (PDA's), based on the Palm, Windows CE, or similar operating system environments for small portable devices, wireless telephones, interactive televisions with set-top boxes for Internet access, Internet kiosks available to the general public, and future Internet appliances, and other consumer electronic devices that may emerge.

Each client 14, 16 preferably executes a graphical viewing application such as a web browser to access resources residing on other resources, such as network server 12 and color image server 18, attached to system 10. A web browser application permits the user associated with client 14, 16 to readily view web pages generated by network server 12, and images served by color image server 18. Other user interface applications may be useful in accessing network server 12 provided the information is presented in a user-interactive format.

In some embodiments, color image server 18 may be configured to deliver color corrected video imagery, in addition to static images. In this case, color image server 18 may be configured to compute video corrections on demand or precompute them for different categories of client devices. Video, such as MPEG clips, streaming video, and the like may suffer from similar color accuracy issues if they are not compensated for the effects of the display device associated with an individual client 14, 16. Thus, some embodiments of the invention may be particularly useful for broadcast-like video content. In the online auction context, for example, a moving, zooming, or rotating view of an item, or display of an item in use or with a model, may be desirable. For a photo site, source clients 14 may desire to upload video imagery.

In each case, source and destination clients 14, 16 include a display device, such as a cathode ray tube or flat panel display, for display of color images obtained from network server 12 and color image server 18. Other types of displays as well as dynamic viewing media such as electronic paper are contemplated. Communication between network server 12, client 14, 16, and color image server 18 may take place using conventional network protocols such as TCP/IP.

Although some of the client devices described above, such as PDA's and wireless telephones, presently incorporate relatively low quality color displays, it is anticipated that such devices will benefit from higher quality color displays in the near future. Accordingly, system 10 will be readily applicable in enhancing the quality of color images displayed by PDA's, wireless telephones, and similar devices in the future.

As an illustration, network server 12 may deliver web pages associated with an item posted for auction. In this example, the web pages delivered by network server 12 may contain descriptive information concerning the item offered for auction, its price, and color images of the items for viewing by online customers. Some of the color images may constitute low resolution “thumbnail” images placed coincident with hypertext links that point to higher resolution images stored at color image server 18. A destination client 14, 16 executes the code delivered by network server 12 within a browser application to assemble a web page for display.

When a user associated with a client 14, 16 clicks on one of the thumbnail images with a pointing device, such as mouse, trackball, pen, or the like, client 14 accesses color image server 18 to obtain the higher resolution color image designated by an image tag embedded in the web page code. To permit display of the higher resolution color image with greater color accuracy, color image server 18 modifies the color image based on the calorimetric information obtained for pertinent source and destination clients 14, 16.

Notably, each image typically will be associated with a single source client 14, i.e., the client who posted the image, and thus a single source profile. The destination clients 16 who may download the image are numerous, however, and present numerous potential destination device profiles. Thus, in modifying a particular image, color image server 18 ordinarily will refer to a source profile that corresponds to a single source client 14 and one of several potential destination profiles that correspond to different destination clients 16.

When a particular destination client 16 requests an image and provides a destination profile cookie, color image server 18 extracts the destination profile, retrieves the source profile associated with the image, and applies the necessary color modifications to the color image. Color image server 18 then serves the modified image to destination client 16. Alternatively, color image server 18 may access an image that has been previously corrected to a standard condition using the source profile, and then apply the destination profile information to produce a more accurate color image for the display device associated with destination client 16.

The color profiling process, and hence improved color accuracy, may be optional, both for source client 14 and destination client 16. For some items, color accuracy may not be significant. When destination client 16 accesses a color image from color image server 18, the destination user may be given a choice between viewing a version of the image with default color settings, which may be less accurate, or viewing a more accurate color image that is modified based on the results of the color profiling process.

The color image initially delivered to destination client 16 by color image server 18 may be embedded in a web page with one or more hypertext links for initiation of the color profiling process. Upon selecting an appropriate link, destination client 16 interacts with color profile server 20 to perform the color profiling process. If the link is not selected, destination client 16 simply views the default image without the benefit of color modification by color image server 18. With the image, destination client 16 also may view an indication of whether color profiling and correction has been applied to the image. The indication may take the form of an icon.

When the user clicks on the hypertext link to start the color profiling process, client 16 accesses color profile server 20 for delivery of a series of instructional web pages to the user. The web pages delivered by color profile server 20 guide the user through a number of steps designed to estimate the colorimetric response characteristics of the particular display device associated with client 16.

When the process is complete, color profile server 20 delivers a web page with content that, when executed, generates a cookie containing the color profile information. The cookie then can be uploaded to color image server 18 for use in modifying the color image, and subsequently accessed color images, to produce higher quality color output on the display device associated with client 16.

Color profiling also may be optional for the source client. When source client 14 uploads an image, the source user may elect either to post the image in its initial state or in a color-corrected state. In this manner, the user associated with source client 14 can decide whether improved color accuracy is necessary. In some embodiments, an auction of photo site administrator may elect to charge a fee, either to the source client 14, destination client 16, or both.

Network server 12 may present the color profiling option to source client 14 when the source client submits a new item for auction or a new photo or set of photos. If improved color accuracy is desired, source client 14 selects the option and performs the color profiling process. Thus, source client 14 may be directed to color profile server 20 via network server 12.

Other techniques for obtaining the color profiling information may not require direct interaction by the user with color image server 18. Instead, the user may voluntarily visit a web site to perform color profiling. The web site may be provided by color profile server 20 or be within the same domain as the color profile server. Alternatively, users may profile the display devices associated with their individual clients 14, 16 by executing software downloaded or physically delivered to them.

FIG. 2 is a block diagram of a web environment 21 incorporating a system as shown in FIG. 1. In the example of FIG. 2, web environment includes an auction server 22, which may serve web pages that support an online auction process via World Wide Web 24. Web environment 21 includes a number of source clients 14₁-14_{N}. Each source 14₁-14_{N} could represent, for example, a seller of an auction item. A number of destination clients 16₁-16_{N} also reside in web environment 21. Many destination clients 16₁-16_{N} may also serve as source clients and vice versa. In other words, some of the clients 16 downloading images of auction items also may upload auction items of their own.

Color image server 18 serves images referenced by the web pages delivered by auction server 22. Color profile server 20 guides the color profiling process by serving web pages to source clients 14₁-14_{N} and destination clients 16₁-16_{N} over World Wide Web 24. Color profile server 20 then transmits the calorimetric information obtained from source clients 14₁-14_{N} and destination clients 16₁-16_{N}, e.g., as source and destination profiles or parametric information, to color image server 18 via World Wide Web 24. Color image server 18 then sends to source clients 14₁-14_{N} and destination clients 16₁-16_{N} web pages that, when executed, generate cookies containing the information. In this manner, the colorimetric information can be used in future downloads or uploads of color images.

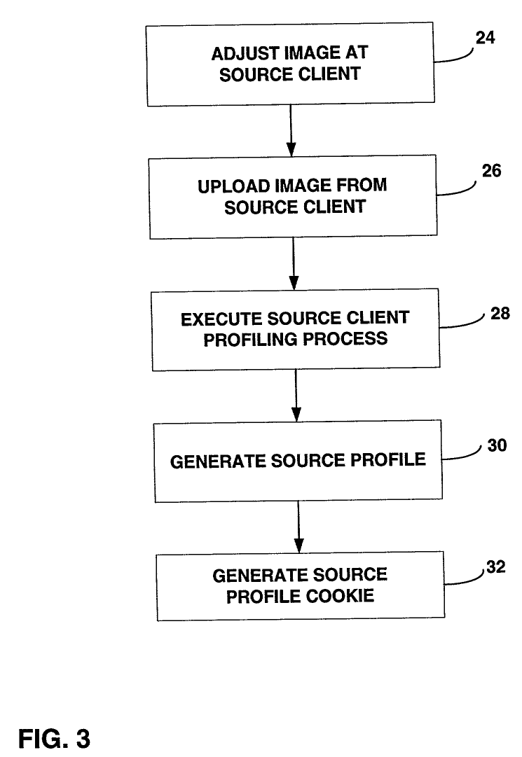

FIG. 3 is a flow diagram illustrating a method for improving color image display accuracy in a computer network as shown in FIGS. 1 and 2. As shown in FIG. 3, the method may include adjusting a color image at a display device associated with a source client 14 (24). Source client 14 uploads the image to color image server 18 (26). Source client 14 also executes a color profiling process (28).

Color profile server 20 guides source client 14 through the color profiling process. Upon completion of the color profiling process, in one embodiment, a source profile is generated (30) either by color profile server 20 or color image server 18. Color image server 18 provides a web page for generation of a source profile cookie containing the source profile (32). The order of the steps shown in FIG. 3 may vary. For example, the color profiling process may precede the uploading of the image.

In particular, the color profiling process may precede or incorporate the step of adjusting the image. This adjustment may involve an initialization of the source client display device to a standard setting, i.e., in terms of brightness and contrast, followed by manipulation of the image using a commercially available image editing tool to achieve an appearance that is acceptable to the source client user. Color profile server 20 may serve web pages that instruct the user to adjust the brightness and contrast to the standard setting level. This step may be optional for the user, and may not be necessary in some embodiments.

The image preferably is edited by the source client user in, or converted to, a browser-viewable format such as jpeg, gif, or png. Alternatively, the image may be in a format that is viewable in a browser via a plug-in. In either case, the user edits the image to an appearance that the user believes accurately matches the actual appearance of an auction item, or a desired appearance for a photo. Then, the user displays the image within the browser and reviews it for accuracy. If the image does not appear acceptable to the user when displayed in the browser, the user may return to the image editing tool. Examples of an image editing tool include Adobe Photoshop or Adobe Photodeluxe software, commercially available from Adobe Systems, Inc. of San Jose, Calif., as well as online photo editing tools accessed via a network such as the world wide web.

After editing the image again, the user returns to the browser, and may repeat the process until an acceptable appearance is achieved in the browser. Once the appearance of the image is acceptable to the source client user and appears as intended, given the optional standard brightness and contrast setting described above, the image is uploaded to color image server 18. If a source profile cookie exists, source client 14 also uploads the cookie. If not, the source client user enters the color profiling process.

Thus, the uploaded image does not include calorimetric information characterizing the display device. The image does, however, represent acceptable color content to the source client user when viewed in a browser with optional standard display device settings, e.g., brightness and contrast. The color profiling process serves to obtain colorimetric information characterizing the output of the source client display device. The color profiling process then involves the delivery of a series of web pages designed to obtain information from the source client user concerning colorimetric characteristics such as blackpoint, gamma, and gray balance.

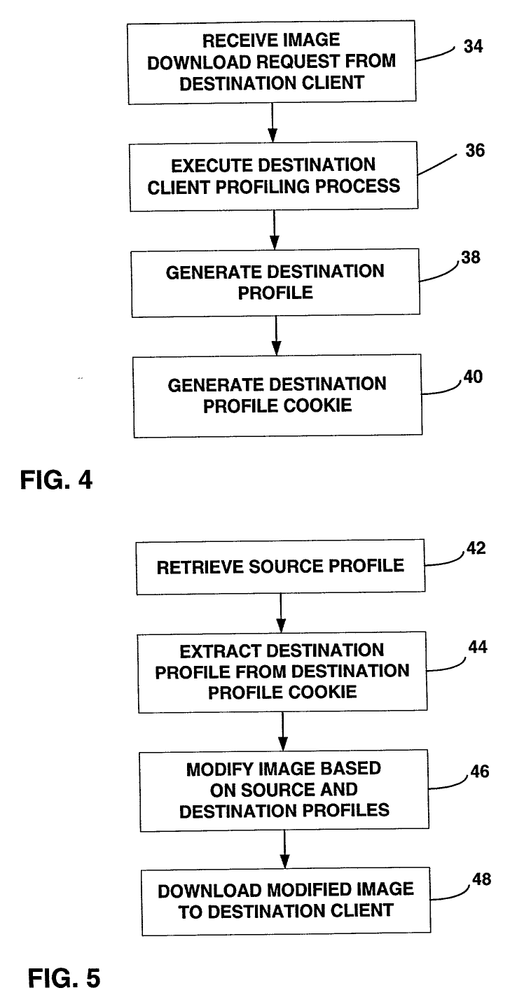

FIG. 4 is a flow diagram illustrating a color profiling process for a display device associated with a destination client. When destination client 16 makes an image download request (34), color image server 18 may provide a redirect or a hypertext link to color profile server 20. As shown in FIG. 4, color profile server 20 serves a series of web pages for execution of a the destination client profiling process (36). The color profiling process is followed by generation of a destination profile (38) containing information obtained from the profiling process, and generation of a destination profile cookie (36). The information can be communicated from color profile server to color image server 18. The destination profile cookie then can be generated (40) by destination client 16 in response to web code received from color image server 18.

FIG. 5 is a flow diagram illustrating a process for modifying color images for improved color accuracy. When a destination client 16 that has already executed the color profiling process requests the download of an image, color image server 18 retrieves the source profile associated with the image (42) and extracts the destination profile from a destination profile cookie uploaded by the destination client (44). Again, color modification may be optional. Color image server 18 then modifies the color characteristics of the requested image based on the source profile and destination profile (46). Color image server 18 downloads the modified image (48) to destination client 16, resulting in improved color accuracy between the images viewed by the source and destination clients.

Interaction between network server 12, clients 14, 16, color image server 18, and color profile server 20 is driven by execution of the web page code delivered to the clients. This approach yields significant convenience for the end user associated with clients 14, 16. At the same time, color image server 18 is not required to retain color information for individual users, and recall that information each time a new image is uploaded or download. Rather, the information can be uploaded to color image server 18, e.g., in the form of a cookie, whenever color images are uploaded by a source client 14 or requested by a destination client 16.

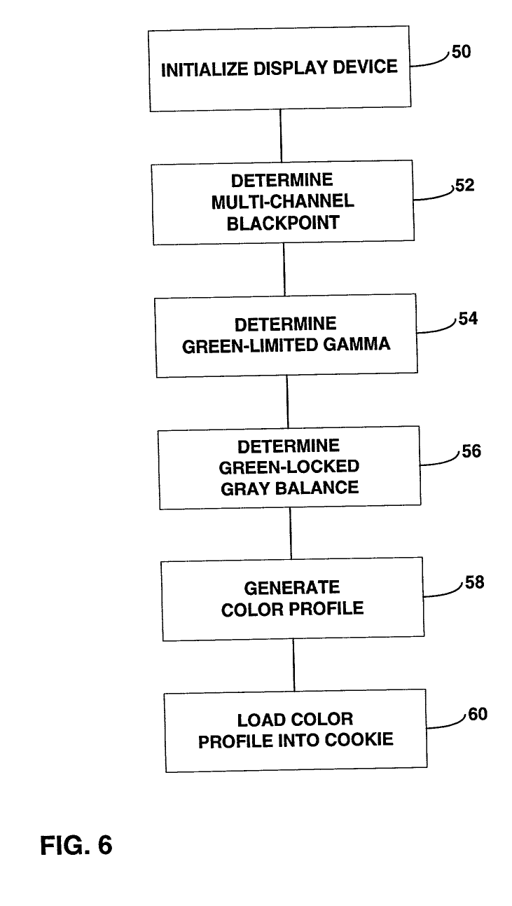

FIG. 6 is a flow diagram illustrating a color profiling process in greater detail. The color profiling process of FIG. 6 is purely exemplary and not limiting of the invention and broadly embodied and described herein. As shown in FIG. 6, the color profiling process for a source client 14 or destination client 16 may involve initialization of the display device to a standard setting (50). The process then involves determination of a blackpoint estimate for the display device (52). The blackpoint estimate may be a multi-channel blackpoint estimate, as will be explained.

Upon determination of the blackpoint estimate, the process obtains an estimate of the gamma for the display device (54). The gamma may be limited to the green channel. Next, the process determines a gray balance for the display device (56). The gray balance estimate can be locked to the green channel in the sense that the green-limited gamma from the gamma estimate may be held constant while red-blue shifts are explored to determine gray balance.

When the blackpoint, gamma, and gray balance have been estimated, a color profile is generated (58). The color profile contains information representing the blackpoint, gamma, and gray balance of the display device. The color profile, or parameters useful in forming the color profile, can be loaded into a web cookie (60). The web cookie is stored by the respective client 14, 16 for uploading when a subsequent image is uploaded or downloaded.

To carry out a color profiling process as described with reference to FIG. 6, clients 14, 16 interact with color profile server 20. Color profile server 20 delivers a series of web pages to clients 14, 16. Each of the web pages is designed to guide the user through a given step in the color profiling process. One web page, for example, may include instructions and image content designed to extract from the user an estimate of the blackpoint of the display device.

In one embodiment, the blackpoint estimate may be an estimate of multiple, channel-specific blackpoints. Other web pages may include instructions and content designed to extract coarse gamma, fine gamma, and gray balance information. In particular, each web page may include interactive media such as hypertext icons and the like that can be clicked upon by the user to transfer information from client 14 to color profile server 20. Upon collecting the necessary information, color profile server 20 creates the cookie and delivers it to client 14 for local storage and future use.

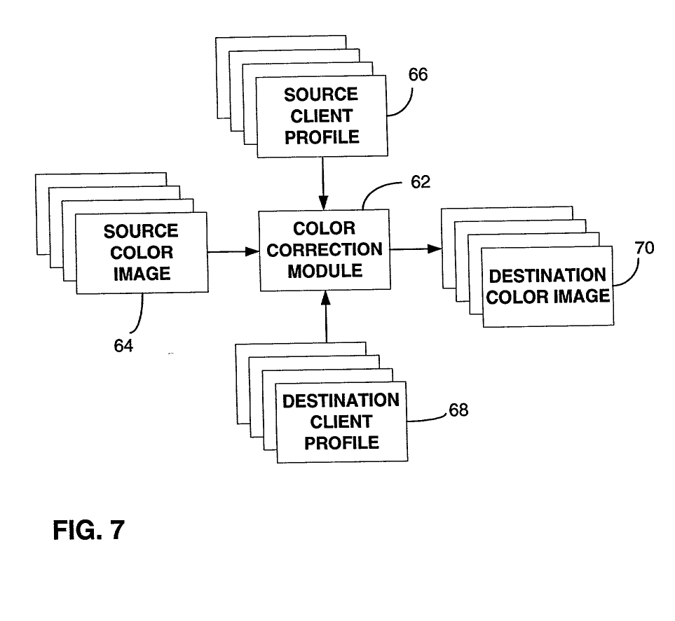

FIG. 7 is a block diagram illustrating a color correction scheme for images uploaded from multiple source clients and downloaded to multiple destination clients. As shown in FIG. 7, color image server 18 includes a color correction module, i.e., a software process running on the color image server. For a given source color image 64, color correction module 62 retrieves a pertinent source client profile 66. Source client profile 66 may be stored in a database or embedded in the source color image 64. Color correction module 62 also obtains destination client profile 68, which can be extracted from a destination profile cookie uploaded by the destination client 16 that requested the image.

Color correction module 62 then generates an appropriate color correction to source color image 64 based on source client profile 66 and destination client profile 68. In this manner, color correction module 62 generates a destination color image 70 that is compensated for calorimetric differences between the display devices associated with source and destination clients 14, 16. Color correction module 62 then downloads the image to the pertinent destination client 16. This process is repeated for each source color image 64 for which color accuracy is desired.

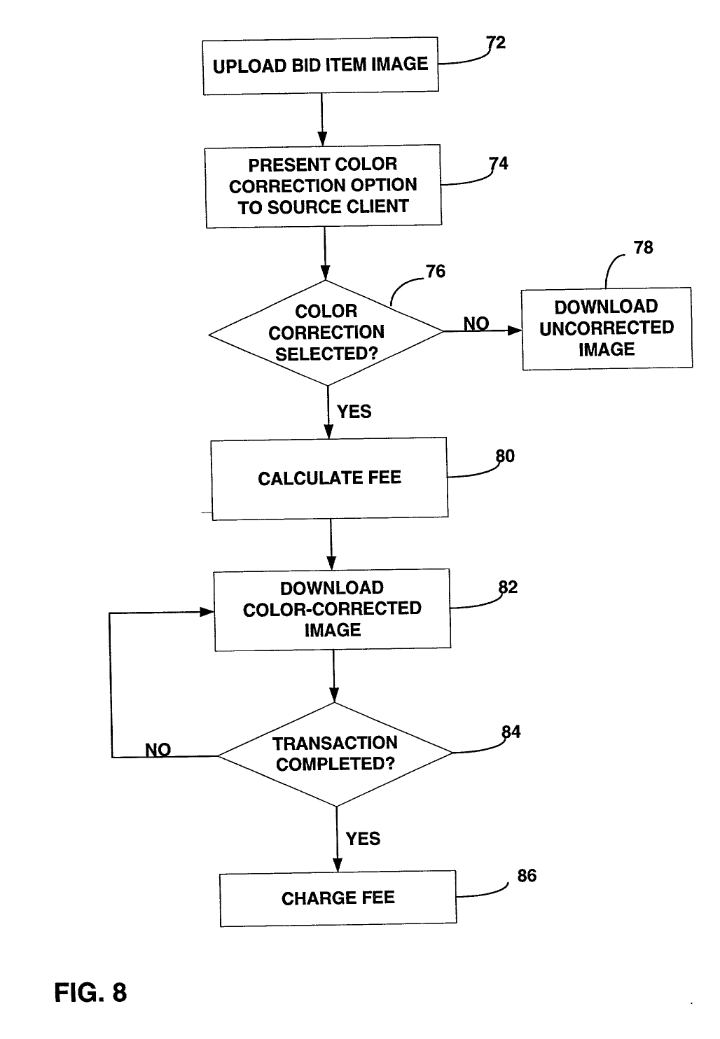

FIG. 8 is a flow diagram illustrating a process for calculating a color correction fee. The color profiling and color correction processes can be made optional. Indeed, color profiling and correction can be offered for a fee, e.g., as a premium service for source clients 14, destination clients 16, or both. Source and destination clients 14, 16 may rely on uncorrected images either as a standard service or at a reduced fee. For some images, color correction will be a desirable option for source and destination clients 14, 16.

FIG. 8 illustrates the example of an online auction site that offers color corrected images for a fee. In this example, the color correction choice is left to source client 14. When a source client 14 uploads a bid item image (72), network server 12 may present a color correction option (74). If source client 14 does not select the color correction option (76), the image uploaded by the source client will be uncorrected. In this case, destination clients 16 that download the image will receive an uncorrected image (78).

If the color correction option is selected, network server 12 calculates a fee for the service (80). Color image server 18 then provides a color-corrected image to destination client 16, provided the destination client has completed the color profiling process. Once destination client 16 downloads the color-corrected image (82), network server 12 monitors the progress of the auction. If a transaction between the source client 14 and destination client 16 is completed (84), i.e., the destination client enters the winning bid, network server 12 charges the fee (86). The fee may be charged to source client 14, destination client 16, or both. Alternatively, the fee may be charged to source client 14 without regard to whether a sales transaction was actually completed.

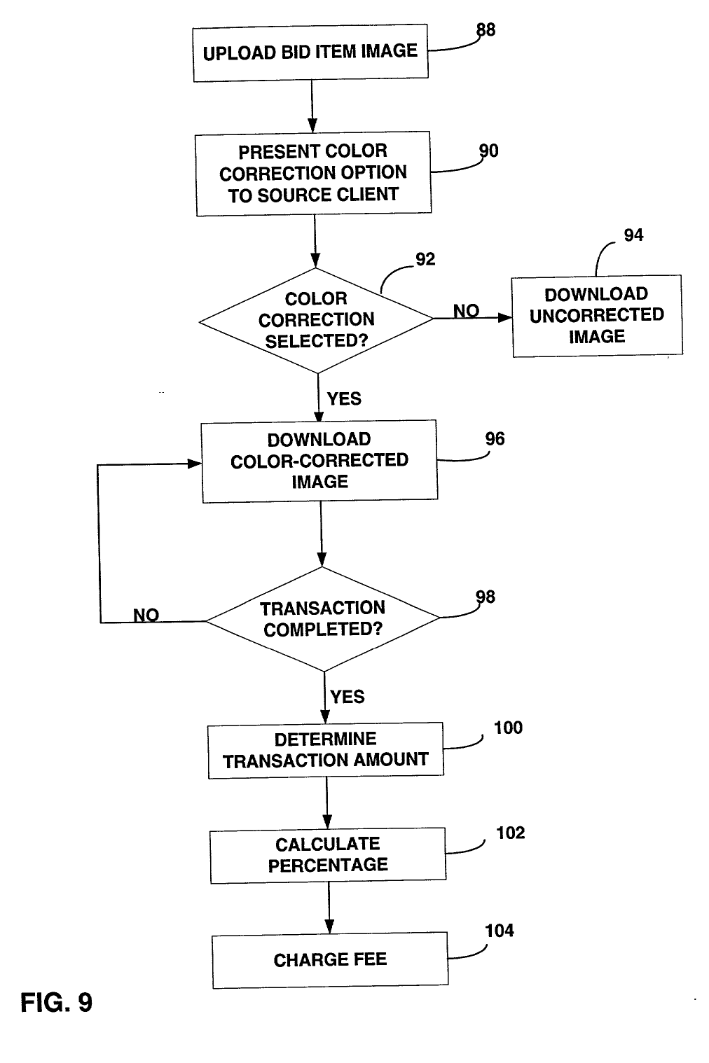

FIG. 9 is a flow diagram illustrating another process for calculating a color correction fee. As in the example of FIG. 8, when a bid item image is uploaded (88), network server 12 presents the color correction option to source client 14 (92). If source client 14 does not select the color correction option, the image uploaded by the source client and downloaded to destination clients 16 will be uncorrected (94).

If the color correction option is selected, color-corrected images are downloaded (96) to destination clients 16, but no fee is calculated. Rather, upon completion of a transaction (98), the transaction amount is determined (100). Then, a fee is calculated as a percentage of the monetary amount of the transaction (102). The fee is then charged (104) to source client 14, destination client 16, or both. In some embodiments, the percentage fee may be capped at a maximum fee.

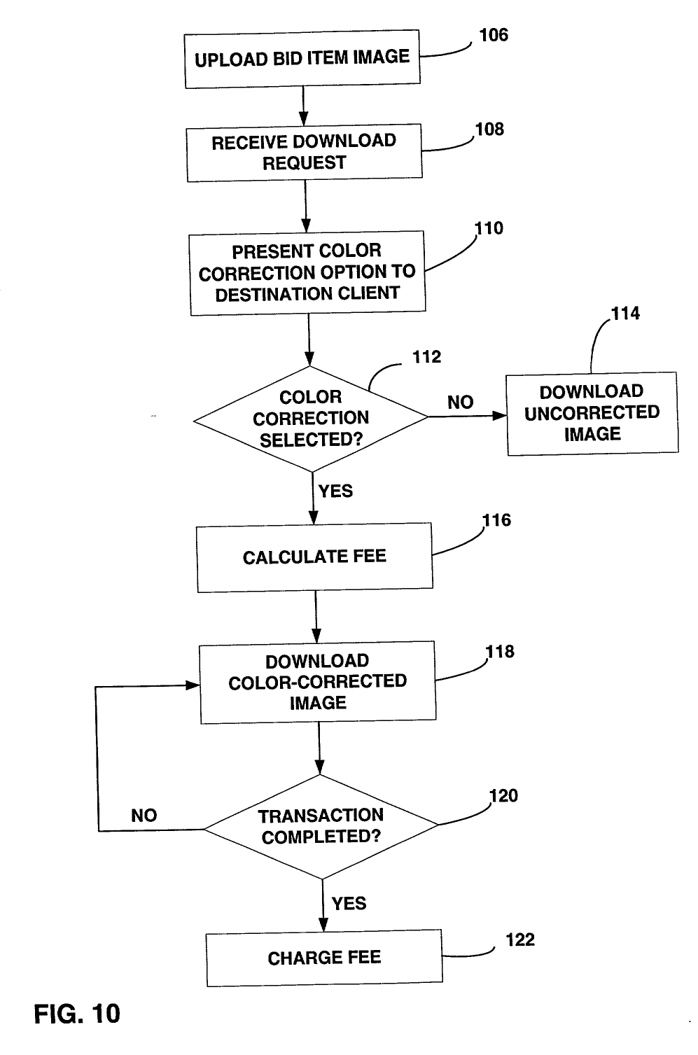

FIG. 10 is a flow diagram illustrating another process for calculating a color correction fee. In the example of FIG. 10, destination client 16 is presented with the color correction option and may bear the fee associated with it. Following the upload of a bid time image (106) from a source client 14, and receipt of a download request from a destination client 16 (108), the color correction option is presented to the color correction option (110).

Presentation of the color correction option presumes that a source profile already is available for the source image. If destination client 16 does not select color correction (112), an ordinary, uncorrected image is downloaded (114). If destination client 16 selects the color correction option (112), however, a fee is calculated (116) for that service. Then, destination client 16 downloads the color-corrected image 118, and network server 12 monitors whether a transaction has been completed (120).

If a transaction is completed, network server 12 charges the fee to destination client 16 (122). The fee may be a flat fee or calculated as a percentage of the transaction amount, as in the example of FIG. 9. In either case, destination client 16 pays the fee for the service of viewing a more colorimetrically accurate image. Destination client 16 may view the fee as worthwhile in assuring that the colors or other characteristics of the bid item are as intended. With color accuracy, destination client 16 can make a buying decision with increased confidence.

The color profiling and cookie management processes will now be described in greater detail. The processes will be described in the context of a web environment having multiple network servers 12, multiple color image servers 18, and one or more color profile servers 20. Exemplary color profiling and cookie management processes are disclosed in U.S. provisional application serial No. 60/193,725, filed Mar. 31, 2000, U.S. utility application Ser. No. 09/631,312, filed Aug. 3, 2000, and U.S. provisional application serial No. 60/246,890, filed Nov. 1, 2000. The content of each of the foregoing patent applications is incorporated herein by reference in its entirety.

The administrator of an auction, photo, retail or other site may control one of the network servers 12 and color image servers 18. In other words, the administrator may be responsible for maintenance, administration, and content of a particular network server 12 and color image server 18. In this manner, the administrators can readily update the contents of network servers 12 and color image servers 18. Consequently, the administrators do not need to relinquish control of their image content to some third party in order to take advantage of color image quality improvements.

Instead, the administrators make use of their own color image servers 18, which interact with a color profile server 20 that guides the color profiling process for source and destination clients 14, 16. Thus, color profile server 20 may be a central server or collection of servers used by multiple administrators, whereas network server 12 and color image server 18 preferably is controlled by an individual site administrator. Nevertheless, in some embodiments, use of a central image server for all sites may be desirable.

Color image server 18 can be a server that is co-located with or remotely located from a corresponding network server 12 and contains the pertinent site's high resolution or color-intensive color images and a color correction module for modifying the images and serving color-corrected images for source and destination clients 14, 16. Each color image server 18 may be within the domain of the respective network server 12, but this is not a requirement.

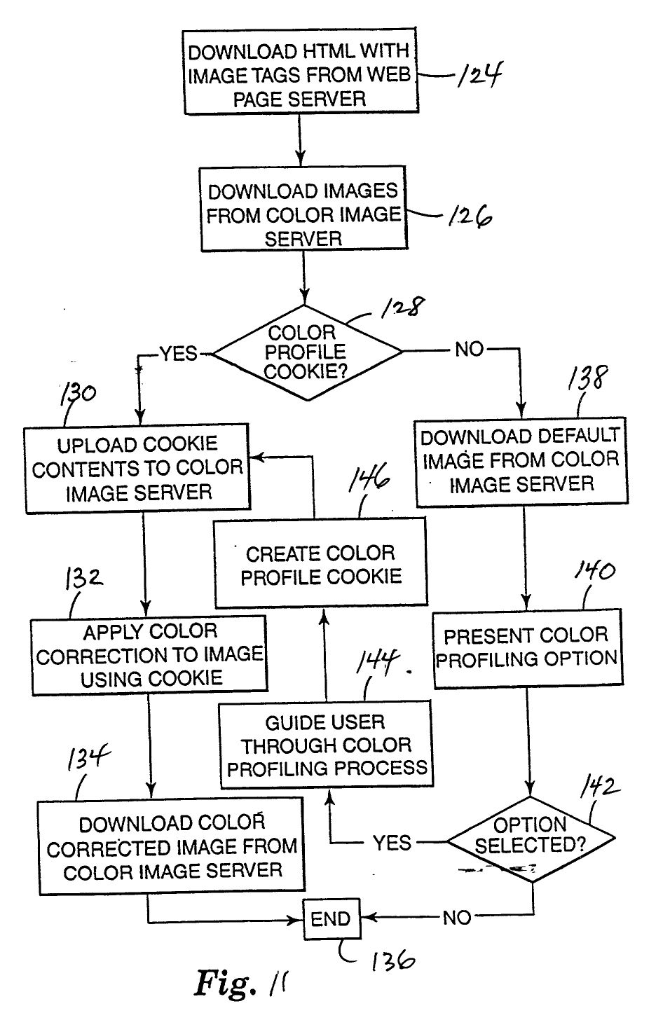

FIG. 11 is a flow diagram illustrating a process for improving color image display accuracy in greater detail. When a destination client 16 seeks to download a web page from a network server 12, the client receives HTML code (or some other form of web page code) with embedded image tags identifying the locations of color images to be incorporated in the web page when it is presented on a display device (124). For lower resolution images, such as so-called “thumbnails,” the image tags may point to locations resident at network server 12. When a user clicks on a thumbnail to access a higher resolution image, or when a higher resolution image is embedded in the web page in the first instance, destination client 16 executes the web page code to access and download color images from a designated color image server 18 (126).

In the example of FIG. 11, the web page code executed by destination client 16 for access to color image server 18 queries whether a color profile cookie visible to the color image server has been generated for the particular client (128). A cookie is visible, for example, if it corresponds to the domain of the color image server. Management of cookies will be described later in this description. The color profile cookie contains information characterizing the color response of the display device associated with client 14, and resides locally with the client.

If a color profile cookie has been generated, client 14 uploads the cookie to color image server 18 (130). Color image server 18 retrieves the image requested by client 14 and modifies the image based on the contents of the cookie by applying a color correction (132). The color correction modifies the image to compensate for variations in the color response characteristics of the display device associated with destination client 16. Color image server 18 then downloads the color corrected image to destination client 16 (134), and the process ends (136). In the above manner, destination client 16 receives a color corrected image that is customized for the client's display device to provide more accurate color output.

If a color profile cookie has not been generated previously, destination client 16 downloads a default color image from color image server 18 (138) for presentation on the display device associated with the client. The image is a “default” image in the sense that it has not been color corrected or otherwise customized for the individual display devices associated with destination client 16. As a result, when displayed by destination client 16, the default image may exhibit significant color inaccuracy relative to the original color image. With the default image, however, client 14 may present a color profiling option (140). In particular, destination client 16 may download with the image an indication of whether color profiling and correction has been applied to the image.

With the image, destination client 16 may display that indication along with a hypertext icon that may invite the user to carry out color profiling. The user may click on the profiling icon with a pointing device to access the color profiling process. In some embodiments, the profiling icon may indicate that profiling has already been performed and that the image has been color corrected, e.g., by displaying the icon in color. If profiling has not been performed previously, the icon may be displayed in black-and-white or some other indication can be provided. By clicking on the icon, the user can commence profiling, either in the first instance or as a profiling update.

If the option is not selected (142) the user simply views the default image and the process ends (136). If the option is selected, however, destination client 16 executes code that directs it to access color profile server 20, e.g., via the hypertext link associated with the icon. Color profile server 20 guides the user associated with client 14 through a color profiling process (144). The color profiling process produces information characterizing the color response exhibited by the display device associated with the particular destination client 16.

Following completion of the color profiling process, client 14 generates a color profile cookie (146). The color profile cookie contains the color characterization information. Destination client 16 then uploads the color profile cookie to color image server (130), to obtain a color corrected image for improved color image accuracy. As will be explained, the cookie may need to be rewritten for the domain of the particular color image server 18.

Notably, as will be described, the color profiling process optionally requires no plug-ins, Java scripts, or other significant client-side processes. Instead, interaction between network server 12, source client 14, destination client 16, color image server 18, and color profile server 20 is via execution of the web page code delivered to source and destination clients. This approach yields significant convenience for the end user associated with destination client 16. At the same time, network server 12 and color image server 18 are not required to retain color information for individual users.

Rather, the information can be uploaded to color image server 18, e.g., in the form of a cookie, whenever color images are requested by a destination client 16. Moreover, site administrators can maintain their own color images at color image servers 18, and provide color correction by incorporating a color correction module capable of handling the color profile cookies uploaded by individual source and destination clients 14, 16. Accordingly, there is no need for the site administrators to post their web pages or images to a central web repository.

To carry out a color profiling process as described with reference to FIG. 11, destination client 16 interacts with color profile server 20. A similar color profiling process can be carried out for each source client 14. However, the color profiling process for source client 14 may involve the initialization of the source client display device to a standard setting and manipulation of a particular image to provide an appearance that is acceptable to the source client user.

Color profile server 20 delivers a series of web pages to a source client 14 or destination client 16, as the case may be. Each of the web pages is designed to guide the user through a given step in the color profiling process. One web page, for example, may include instructions and image content designed to extract from the user an estimate of the blackpoint of the display device.

In one embodiment, the blackpoint estimate may be an estimate of multiple, channel-specific blackpoints for the individual color channels of the display device. Other web pages may include instructions and content designed to extract coarse gamma, fine gamma, and gray balance information. In particular, each web page may include interactive media such as hypertext icons and the like that can be clicked upon by the user to transfer information from source client 14 or destination client 16 to color profile server 20.

Upon collecting the necessary information, color profile server 20 creates the cookie and delivers it to the source client 14 or destination client 16 for local storage and future use. In some embodiments, two cookies can be provided to source or destination client 14, 16. A first cookie may correspond to a domain name associated with color profile server 20, and be used for future interaction between the particular destination client 14, 16 and the color profile server. The first cookie can be referred to as the “profiler cookie.”

A second cookie may correspond to a domain name associated with the particular color image server 18, e.g., corresponding to a particular auction or photo site, from which the color image is to be downloaded. In other words, the second cookie may correspond to the particular color image server 18 at which the color profiling process was initiated. In this manner, future images delivered by that color image server 18 will be modified based on the contents of the cookies associated with the pertinent domain. The cookies will be provided by the source client 14 that uploaded the image, and the destination client 16 that request a download of the image. The second cookie can be referred to as the “image server cookie,” and may take the form of a source profile cookie or a destination profile cookie.

The profiler cookie can be used to produce additional image server cookies for use with color image servers 18 associated with other domains. Specifically, when a user situated at a destination client 16 accesses a color image server 18 from which the user has not previously downloaded color corrected images, the user can click on the color profiling option and be directed to color profile server 20. Upon interaction with color profile server 20, destination client 16 simply uploads the profiler cookie instead of repeating the color profiling process. Information concerning the domain associated with the new color image server 18 can be incorporated in the profiler cookie. A similar process can be provided for source client 14.

In response to receipt of the profiler cookie, color profile server 20 delivers a web page advising the user associated with source or destination client 14, 16 of the intent to send the cookie contents to the domain indicated in the cookie, and may request user approval for, among other reasons, privacy concerns. Upon approval by the users, color profile server 20 transmits the cookie contents to the color image server 18 designated by the domain in the profiler cookie.

Color image server 18 creates an image server cookie for its own domain, and writes the cookie to source client 14 or destination client 16 or future use. Thereafter, destination client 16 uploads the appropriate image server cookie to the pertinent color image server 18 when requesting color corrected images for the pertinent network server 12, and can bypass interaction with color profile server 20. Source client 14 uploads the appropriate image server cookie to color image server 18 when attempting to upload images.

The reliance on first and second cookies, one for color profile server 20 and the other for a particular network server 12 or color image server 18, is driven in part by existing web design considerations. In particular, cookies stored on a client's browser typically are marked by the domain of the server that generates them, and are not generally visible to other domains. Thus, cookies created by color profile server 20 are not generally visible to color image servers 18, and vice versa.

Further, cookie visibility can be further restricted by marking the cookie with a path within a server's domain. This sort of cookie will then not be visible on requests to pages outside the path, even if to the same domain. Further, a browser routinely sends all visible cookies on each request to a server. This includes not only the initial request for an HTML page, but also the requests for images to be embedded in the page. Because an image can come from a different server than the HTML page, however, the cookies sent for the HTML page can differ from those sent for the image.

In light of the above considerations, color profile server 20 acts as an intermediary not only for administration of the color profiling process, but for generation of image server cookies. This intermediary function enables color correction of all subscriber images to be performed at color image servers 18 rather than at a centralized site. Also, with this intermediary function, once a client has gone through the color profiling process, he generally will not have to repeat it to obtain color correction of images for additional subscribers.

As an exception, the user may voluntarily repeat the color profiling process when local driver software or hardware such as the display device or video card associated with a source or destination client 14, 16 has changed. Indeed, to encourage updates from time to time in order to accommodate hardware changes, expiration dates can be applied to the profiler cookie and image server cookies.

It is apparent that the three different servers, i.e., network server 12, color image server 18, and color profile server 20, divide the labor involved in color correction transactions. In particular, assuming the existence of a profiler cookie and an image server cookie, a network server 12 serves the HTML for the subscriber's own web pages and handles most other requests for those pages, including serving of images that are not subject to color correction. Color image server 18 serves the images that are subject to color correction.

If color image server 18 receives a destination profile cookie from a destination client 16, it performs color correction based on the cookie contents and they contents of the pertinent source profile cookie, and serves the color corrected image to the destination client. Color image server 18 also may serve an icon near the correctable color images that indicates whether the color images have indeed been corrected. If color image server 18 finds no destination profile cookie, for example, it displays an icon suggesting that the user click the icon to initiate the color profiling process. Otherwise, the icon merely indicates that color correction is turned “on,” i.e., that color correction has been applied to the image.

Color profile server 20, as mentioned above, serves the pages for the color profiling process. If the color profiling process is invoked by clicking the icon displayed with a color image delivered by color image server 18, the respective destination client 16 probably does not have an image server cookie for the pertinent network server 12. In some cases, however, destination client 16 may be voluntarily repeating the color correction process to update the profile for new hardware or software. If a profiler cookie exists, then the process can be abbreviated by simply shipping the contents of the cookie to the appropriate image server domain for creation of the image server cookie.

If the profiler cookie does not exist, then the full color profiling process is served by color profile server 20. Upon completion of the color profiling process, color profile server 20 generates the profiler cookie for the source or destination client 14, 16, and passes the contents of the profiler cookie to the pertinent color image server 18. Color image server 18 then generates the image server cookie based on the profiler cookie contents and invokes the original network server URL from which the color profiling process was invoked.

The mechanisms for exchanging color correction information between the profiler cookie generated by color profile server 20 and the image server cookie generated by color image server 18 may vary. In particular, rather than delivering cookies to clients 14, 16, color profile server 20 may be arranged to transmit the color correction information to all of the color image servers 18 associated with a recognized group of network servers 12. In this manner, the color profile information obtained by color profile server 20 as a result of the color profiling process can be “broadcasted” for storage by network servers 12 or color image servers 18. The advantage of this approach is that information transfer is seamless. There is no need for the user associated with a client 14, 16 to interact with color profile server 20 following the initial color profiling process, other than to update the color profile. Rather, each network server 12 or color image server 18 stores the color correction information associated with the individual destination client 14, 16, e.g., with a client ID code.

When a source or destination client 14, 16 accesses one of the color image servers 18, the client ID code is used to retrieve the appropriate color correction information and thereby serve a color corrected image. The downside is that each network server 12 or color image server 18 may need to maintain a database of color correction information for source and destination clients 14, 16, including clients who may never access a respective network server 12. Thus, an approach that makes use of cookies for transfer of color correction information may be more efficient and more desirable for some site administrators. Nevertheless, broadcasting of color correction information remains a viable option that may be acceptable to some site administrators, and highly convenient for end users.

The following is a description of some of the details that may be involved in passing information between network servers 12, clients 14, 16, color image servers 18, and color profile server 20 according to an indirect cookie transfer approach. This approach is indirect in the sense that the user intervenes and enters approval before the profiler cookie contents are transferred from color profile server 20 to a respective color image server 18. In delivering web pages to destination clients 16, network server 12 passes the URL's for correctable images stored on associated color image servers 18. In addition, network servers 12 preferably incorporate color profiling icons near the images. URL's for the color profiling icons point to the pertinent color image server 18, while the hypertext link associated with the icon points to color profile server 20. For source clients 14, a similar icon or other link can be provided as part of the process of submitting a photo or auction item image.

To accomplish passing of color correction information back to color image server 18, the URL of the page viewed by the user is passed to color profile server 20 when the hypertext link associated with the icon is followed by a source or destination client 14, 16. This step of passing the URL can be accomplished either by including the URL as a parameter on the target URL, or by POSTing the information from a form that wraps the icon, i.e., with the URL stored in a hidden entry field. In the latter case, the icon serves as a button, which may require some minimal client-side scripting. In addition, as will be described, the name of network server 12 and the URL of a completion page to be served by color image server 18 after the color profiling process is complete may be included in the request to color profile server 20. Network servers can be provided with a server-side scripting function that inserts the icon code with the appropriate URLs.

For the color profiling process, color profile server 20 serves a number of web pages that can be invoked by execution of a web page provided by network server 12. In this case, the “return URL” is passed forward to each page in the sequence. The return URL can be passed as a parameter in the target URL, or by using hidden fields in forms. In some cases, the return URL can be stored as a server variable. As mentioned above, color profile server 20 handles two scenarios: (1) full color profiling when no profiler cookie exists, and (2) creation of an image server cookie when a profiler cookie already exists. In both scenarios, color profile server 20 transfers the contents of the existing or newly created profiling cookie to the pertinent color image server 18. In particular, color profile server 20 may present a button that requests permission of the user associated with a source or destination client 14, 16 to transfer the information.

The URL for the button points to a page served by color image server 18. The request sent to color image server 18 includes both the return URL and the color information written in the profiler cookie. The request preferably is a POST request from a form, rather than a GET request with all the information set forth in the URL due to length considerations. Color profile server 20 determines the URL of the destination page at color image server 18 by reference to the return URL. Prior to transfer of the cookie contents, the user will want to know the destination. Accordingly, color profile server 20 displays the name of the particular color image server along with the button. The name of the color image server may be associated with the web site served by network server 12. If the name of the web site is not easy to determine from the URL, it can be generated by cross-referencing the URL to a name in a database accessible by color profile server 20, or by passing the name with the return URL in the original request from the page generated by network server 12.

Upon receipt of the information from color profile server 20, the pertinent color image server 18 serves a page indicating that the color profiling process is complete. The page may be invoked by the POST request containing the color correction information and the URL of the “return” page, as received from color profile server 20. Color image server 18 writes the color correction information to the pertinent source or destination client 14, 16 as a client cookie.

From that point forward, the image server cookie is stored by the respective source or destination client 14, 16, and is sent to the color image server 18 associated with the pertinent web site with any request for upload or download of a color correctable image. In response to a download request, color image server 18 extracts the contents of the image server cookie from the destination client 16, applies a color correction to the requested image based on the contents, and delivers the color-corrected image to the destination client 16. In response to an upload request, color image server 18 accepts the image, extracts the contents of the image server cookie from the source client 14, and associates the cookie contents with the image for future use.

As an alternative approach, color correction information can be passed from color profile server 20 to a color image server 18 via a direct request, rather than being embedded in a request generated when a source or destination client 14, 16 clicks on a button, anchor, or other input medium. This approach is direct in the sense that the user need not intervene by submitting approval for the transfer to color profile server 20. Instead, the transfer of the content of the profile cookie to the appropriate color image server 18 can be made seamless and occur in the background.

Indeed, in preferred embodiments, the user associated with destination client 16 may not even view pages sent by color profile server 20 for transfer of information following the initial profiling. In this manner, the transfer of color correction information from color profile server 20 to a color image server 18 happens automatically, without requiring the user associated with a source or destination client 16 to click on a link to effect the transfer. This approach makes the transfer appear more seamless to the user. The end result is the same, i.e., the transfer of color correction information contained in a profiler cookie to create an image server cookie without the need for reexecution of the color profiling process by the user.

To facilitate transfer by direct request, a source or destination client 14, 16 can be assigned a client ID. Ordinarily, the client ID can be stored in and received from an image server cookie on the browser associated with a client 14, 16. A client 14, 16 that is new to the particular web site, i.e., a client that does not send an image server cookie to the particular color image server 18, will be assigned a new client ID, which is sent as a cookie with the HTML in the response from the color image server.

All URLs pointing to color profile server 20 then bear both the client ID and a web site ID as parameters, so that the color profile server can correlate requests for color correction information for the respective client 14, 16. The URL for the color profiling icon points to color profile server 20 if there is no image server cookie. For this approach, it is preferred that the respective network server 12 and corresponding color image server 18 occupy the same domain so that they can view the same cookies.

As in the indirect approach, a color profiling icon, which appears adjacent a color correctable image or with a dialog for upload of an image, may be served from either color image server 18 or color profile server 20 in the direct transfer approach, depending on whether the color image server receives an image server cookie. If an image server cookie is present, the profiling icon is served by color image server 18 with a downloaded image, and is formulated in appearance to indicate that color correction is active, e.g., with a text message to that effect. This will be the case for most images served by color image server 18 because only new destination clients 16 will not have the image server cookie.

If the image server cookie is not presented, the icon is served by color profile server 20. In other words, the web page served by color image server 18 has embedded in it an icon served by color profile server 20. If a profiler cookie is present, color profile server 20 serves an icon that indicates the client 14, 16 has already been through the color profiling process. If not, the icon indicates that the color profiling process has not previously been completed by the respective client 14, 16. This may be represented by a colored icon to indicate that color profiling has been completed, and a black-and-white icon to indicate that it has not.

In some embodiments, the icon may indicate that the client 14, 16 has been through the color profiling process, but that the color correction information has not yet been forwarded to the particular web site, and that the image has not been color corrected. In either case, color profile server 20 also receives the ID for the client 14, 16 and the particular web site, which are included in the URL forwarded to color profile server 20. If the profiler cookie is present, color profile server 20 immediately forwards the client ID and the contents of the profiler cookie to the pertinent color image server 18 in a special-purpose request.

If the image server cookie is presented by a destination client 16, color image server 18 performs the color correction based on the information contained in the cookie. For a source client 14, color image server 18 accepts the contents of the image server cookie and associates it with the uploaded image for later retrieval during color modification. If the image server cookie is not present, color image server 18 waits a short time to receive color information for this client 14, 16 from color profile server 20. If the information is forthcoming, color image server 18 writes an image server cookie to the browser associated with the client 14, 16. Otherwise, color image server 18 serves an uncorrected image to destination client 16 or, in the case of source client 14, does not establish information for color correction of the uploaded image.

With this direct approach, it may be necessary for color image server 18 to keep track of color correction information forwarded by the color profile server 20 because such information may not be received synchronously with image upload and download requests from clients 14, 16, respectively. Accordingly, it may be necessary to incorporate a database application that can be shared by color image server 18 for temporary tracking of color correction information associated with individual clients 14, 16, and network server 12 for tracking and generation of client ID information. Once the information has been written to an image server cookie, the ID and color correction information for the respective client 14, 16 can be purged from the database.

Management of ID's according to the direct transfer approach may take place as follows. The original color correction information generated by color profile server 20 can be stamped with a unique ID. The unique ID can be maintained in copies of the color correction information forwarded to color image servers 18. This ID changes if the client 14, 16 repeats the color profiling process, and can be referred to as the profiler ID. The profiler ID will remain unchanged until the next pass through the color profiling process, which may occur months later. In effect, the profiler ID corresponds to a particular color profiling sequence. The profiler ID is supplemented by the client ID and the subscriber ID. The client ID identifies a client for whom a web site is requesting color information, and the subscriber ID identifies the particular subscriber.

The client and subscriber IDs are passed via URL parameters to color profile server 20 whenever a color image server 18 has no color correction information for a particular client 14, 16. The subscriber ID is passed back with the color correction information from color profile server 20 to color image server 18 when the color profile server determines the appropriate information for the client, based on the contents of a profiler cookie or the results of running the color profiling process. Once color image server 18 receives this information and writes it as an image server cookie to the client's browser, the subscriber ID is no longer needed.

A process as shown in FIG. 12 can be used to generate the contents of a profiler cookie as discussed above with reference to FIG. 11. Notably, the entire color profiling process can be completed by the user associated with a source client 14 or destination client 16 with as few as three “clicks” of a pointing device. If the user is required to click a continue button to proceed after selecting a patch, the process may take additional clicks. If the user is permitted to proceed automatically following selection of a patch, however, the entire process can be completed in three clicks. With optional analog adjustment, separate R,G, and B blackpoints, and fine gamma steps, to be described, the process may require up to six or seven clicks. In many embodiments, the color profiling process requires no plug-ins or client side scripting when utilizing the method of selecting discrete elements, although such mechanisms can be provided in some embodiments such as in the use of slider adjustments.

The color profiling process enables visual profiling of a display device associated with a source client 14 or destination client 16 by determining accurate values of blackpoint and gamma for the R,G, and B phosphors or photodiode elements. Gamma refers to a parameter y that indicates the rate of change in light intensity with change in digital device value. The term “blackpoint” is well known in the art and refers to the R, G, or B values lower than which there is no decrease in light emitted by the display device. Blackpoint is sometimes alternatively referred to as black onset. In accordance with the invention, three separate blackpoints are optionally determined, one for each of the R, G, and B color channels of the monitor. For use with more accurate monitors, a single dark gray RGB selection can be used to estimate a single average blackpoint value for R, G, and B.

In some display devices, such as older CRT monitors, different color channels can produce very different blackpoints. Accordingly, reliance on a single RBG blackpoint measurement in generating a color profile can introduce inaccuracies. Determination of channel-specific blackpoints, however, can reduce the degree of inaccuracy. In other words, by estimating the blackpoint for each color channel individually, a more accurate characterization of the calorimetric response of the display device can be obtained. A more accurate calorimetric characterization enables greater accuracy in conversion of color images for delivery and display on the particular monitor. For purposes of example, alternative color profiling processes are disclosed in U.S. patent application Ser. No. 09/631,312, to Kruse et al., filed Aug. 3, 2000, and entitled “COLOR IMAGE DISPLAY ACCURACY ACROSS A GLOBAL COMPUTER NETWORK,” the entire content of which is incorporated herein by reference.

Color profile server 20 may administer a color profiling process as shown in FIG. 12 by serving a series of instructional web pages to clients 14, 16. In general, the color profiling process may involve determination of (1) blackpoint for each of the red, green, and blue (R, G, and B) color channels of the display device, (2) average gamma for R, G, and B, and (3) differences in gamma for R, G, and B. Due to the wide range of differences in display device properties, determination (2) above can be subdivided into determination of (2a) a coarse gamma estimate, and (2b) a fine gamma estimate. This process is described in greater detail below with reference to FIGS. 12-18.

The color profiling process first involves determination of an estimated blackpoint for each of the color channels of the color display device, e.g., R, G, B. After determining the blackpoints, which may be merely an estimate, the color profiling process involves determination of the gamma exhibited by the display device. In particular, the process may involve determination of a coarse gamma, followed by determination of a fine gamma. Determination of the fine gamma may rely in part on the coarse gamma. In other words, the coarse gamma can be used as an initial estimate and starting point for convergence toward a more finely tuned gamma.

After determining the fine gamma, the process may involve determination of the gray balance exhibited by the display device. Gray balance provides an indication of the amount of color shift of a neutral gray toward one or more of the color channels used by the display device, e.g., red, green, and blue. The gray balance determination may rely in part on the gamma determined previously in the color profiling process and, in a particular embodiment, the fine gamma. Next, the color profiling process involves generation of a color profile. The color profile contains information that characterizes the color response of the display device based on the blackpoints, gamma, and gray balance. The color profile then can be loaded into a cookie, or other content container, and stored locally with each client 14, 16 for uploading to any of color image servers 18 when needed.

The estimated blackpoint parameters define the dynamic range of the display device. Because the maximum RGB value always defines white, the blackpoint defines the black end point, and therefore defines the domain of values for each of the R, G, and B color channels that results in a continuous change from black to white. Again, blackpoint refers to the R, G, or B value below which there is no further decrease in light emitted by the display device. For an individual color channel, such as R, the blackpoint is the point at which further decreases in the R value produce no further decreases in R channel light emitted by the display device. If the blackpoint for a given color channel of a display device is high, values for that channel in darker regions will be mapped to the darkest shade and shadow detail will be lost if no image correction is performed. Accordingly, obtaining an accurate blackpoint estimate is important for the accuracy of images represented by the display device.

In addition to a multi-channel blackpoint estimate, the color profile may include a gamma parameter and a gray balance parameter. The parameters together define the calorimetric response of an individual display device to enable modification of color imagery for more accurate representation on the device. The gamma parameter most affects the overall appearance of the image. Gamma determines whether an image appears overall too light or dark, or with too much contrast or too little. The third parameter, R, G, B gamma difference or “gray balance,” is important because the human eye is very sensitive to gray balance. The gray balance parameter indicates the relative balance, or imbalance, between the different color channels of a display device when producing RGB color combinations.

FIG. 12 is a flow diagram illustrating a color profiling process in greater detail. As shown in FIG. 12, for blackpoint determination, color profile server 20 first may serve a web page for display device adjustment. The web page instructs the user to adjust the brightness and contrast of the display device. This step of display device adjustment is optional, but generally desirable in preparing the display device for blackpoint determination. Color profile server 20 may serve a web page containing several rows of dark elements such as bars, patches, characters, letters, numerals, and the like (148).

Instead of patches or bars, it may be desirable to display elements with alternative shapes such as numerals. Whereas the patches or bars may be generally rectangular, more complex shapes can be used to aid the human eye in resolving differences. Thus, numerals, letters, and other complex shapes, for example, engage the pattern recognition capabilities of the human eye and can result in heightened sensitivity to gray scale differences. When the human eye is called upon to perform pattern recognition, its sensitivity to color gradations between a given pattern and a surrounding area increase. The complex shape presents a longer boundary relative to simple shapes, and promotes an increased perimeter for contrast. Elements with complex shapes may be used in the blackpoint, coarse gamma, and fine gamma determinations to characterize the monitor.

As an alternative to rows, the elements can be arranged in columns placed side-by-side across the web page. As a further alternative, each row or column may contain, instead of several elements, only one or a small number of elements. A larger number of elements in each given row may aid the user in resolving differences between elements in adjacent rows.

The web page may instruct the user to set the brightness and contrast of the display device to maximum (150). The rows (or columns) of elements may be arranged in a series. The elements in each row preferably exhibit the same darkness or lightness. However, the elements in each row in the series differ in relative darkness or lightness relative to the elements in other adjacent rows. For example, the darkest row of elements could be situated at the bottom, with rows containing elements with progressively lighter shades being situated above in ascending or descending order. The web page instructs the user to reduce the brightness until the darkest row of elements is barely visible (152). At this point, the user may select “next” or some similar hypertext icon and proceed to the next step in the color profiling process, e.g., blackpoint determination for each of the red, blue, and green channels on an individual basis.

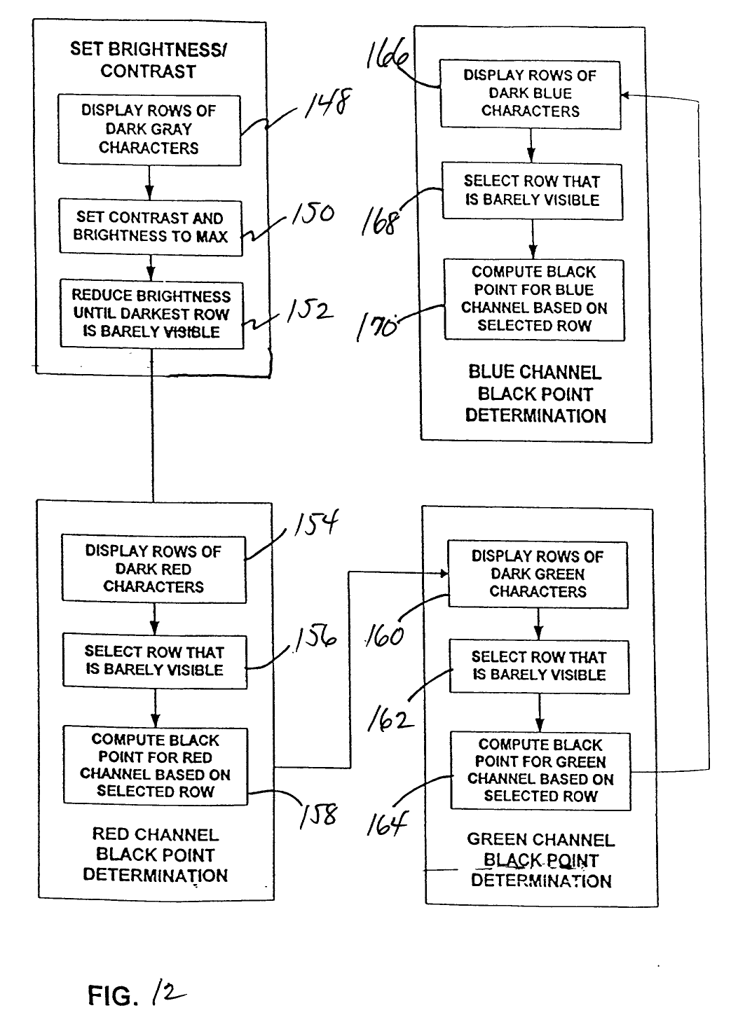

FIG. 13 illustrates a web page 153 for use in display device adjustment in a color profiling process as shown in FIG. 5. Rows 155 of dark elements are displayed, with the elements each row having the same gray level value, but different gray level values from elements in adjacent rows. As an example, rows 155 of dark elements (shown as numerals in the example of FIG. 13) may be presented to the user with the following gray level values: 8, 16, 24, and 32. In other words, the rows of “zeros,” “ones,” “twos,” and “threes” may have gray levels of 8, 16, 24, and 32, respectively. As the rows of dark elements are displayed, the user is instructed to set brightness and contrast of the display device to maximum, using the analog or digital controls provided with the display device. The user is then further instructed to reduce the brightness of the display device until the row with the darkest (lowest gray level value) elements is barely visible, and then click “next” upon completion. This optional step of display device adjustment serves to prepare the monitor for the blackpoint determination carried out with respect to each color channel, as described below.

To carry out the blackpoint determination process for each color channel, several rows (or columns) of elements for each color channel may be displayed on successive web pages. Specifically, red channel, blue channel, and green channel web pages for channel-specific blackpoint determination can be served to the client in any order. In each case, the elements for a given color channel may be arranged in rows in ascending or descending order of relative lightness or darkness, as in web page 153 of FIG. 13, which is served for display device adjustment. The rows provide a sequence of gray level gradations. The bottom row for the red channel blackpoint determination web page, for example, may be a row of “zeros” having elements bearing the darkest shade (lowest gray value) of red among the elements shown on the web page. As with web page 153, arrangement of the elements in rows or columns is for purposes of illustration. In some embodiments, display of a series of individual elements (rather than rows of elements) may suffice.

The row of darkest elements that is barely visible to the user will depend on the blackpoint for the respective channel of the display device. The rows of elements are displayed against a black, i.e., RGB=0, background. With some display devices, the user may be unable to see elements with intensity levels of 8, 16, or higher. The user is instructed to select the row of elements that is barely visible on the display device and most closely matches, or blends with, the black background. This step determines the blackpoint, i.e., the visible “cut-off” point at which further decreases at which further decreases in the color channel value produce no further decreases in light emitted by the display device for that color channel. As an alternative, the user could be prompted to make the least visible row of elements vanish for a given color channel and then click on the remaining barely visible bar. In either case, the blackpoint can be estimated.

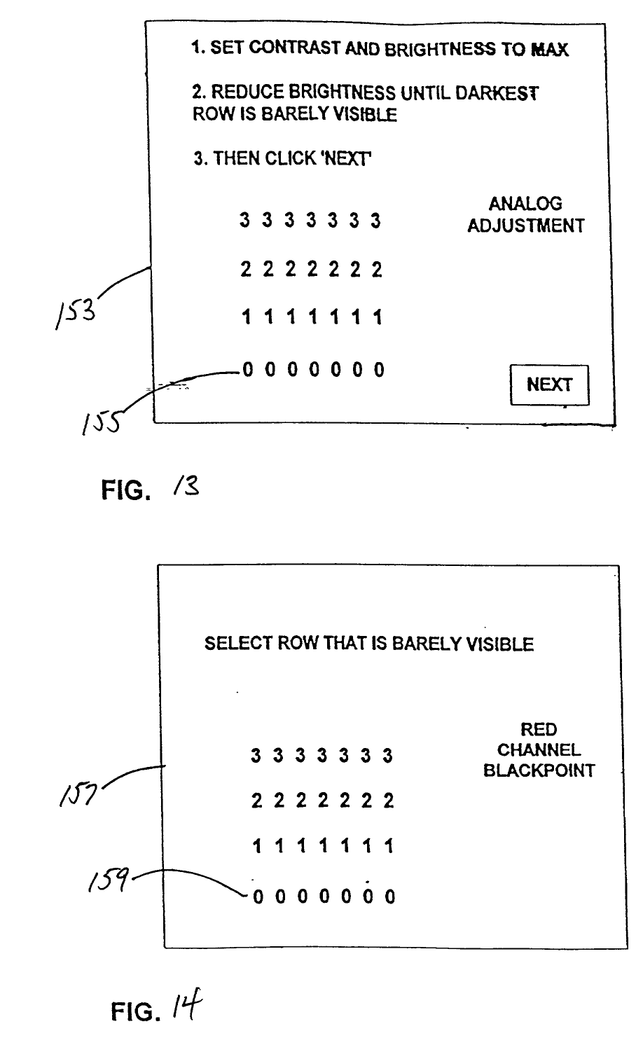

FIG. 14 illustrates a web page 157 for use in blackpoint determination in a color profiling process as shown in FIG. 12. Web page 157 may be substantially similar to web page 122 of FIG. 6. For example, web page 157 may include rows 159 of shaded elements. Again, display of columns of elements or a series of elements may be sufficient for some applications. As shown in FIG. 14, web page 157 instructs the user to select the row of elements that is barely visible on the display device. As in web page 153, the rows 159 in web page 157 may be arranged as rows of “zeros,” “ones,” “twos,” and “threes” having, for example, intensity levels of 8, 16, 24, and 32, respectively. Web page 157 in FIG. 14 represents the web page for red channel blackpoint determination, and includes rows of red elements set against a black background.

Upon selection of the row that is barely visible for the red channel, e.g., upon clicking on any element in the row, the user is automatically served a substantially identical web page containing rows of green elements set against a black background for purposes of determining the green channel blackpoint. Following selection of a row of green elements that is barely visible, a substantially identical web page for blue channel blackpoint determination is served to the user and the user makes a similar selection. Thus, successive web pages governing blackpoint determination for each color channel can be served automatically following selection of a row for a preceding channel. Alternatively, the user may be prompted to click on a “next” icon or similar device. Serving successive web pages automatically following selection of an element may be desirable, of course, to reduce the overall number of clicks involved in the process.

In the above manner, the user selects the row of elements that is barely visible for each color channel, and thereby provides an indication of the blackpoint for each color channel. FIG. 12 further illustrates the process. In particular, FIG. 12 shows the display of rows of dark red elements or characters (154), and selection of the row that is barely visible (156), and further illustrates the computation of the estimated blackpoint for the red channel based on the selected row (158). Similarly, for the green channel, a row of dark green characters is displayed (160), followed by selection of the row that is barely visible (162), and computation of an estimated blackpoint for the green channel based on the selected row (164). Finally, for the blue channel, a row of dark blue characters is displayed (166), followed by selection of the row that is barely visible (168), and computation of an estimated blackpoint for the blue channel based on the selected row (170).

Following selection of the barely visible row of elements displayed on each successive web page, the pertinent source client 14 or destination client 16 transmits the result to color profile server 20. Alternatively, the results for all color channels can be transmitted at the same time following completion of the blackpoint determination for the last color channel. Color profile server 20 then may compute the estimated blackpoint for each channel or simply store the parameters for later computation, e.g., by color imager server 18.

The complete description of the display device behavior can be represented by the following equation which relates RGB to XYZ:

$$[ \begin{matrix}X \\ Y \\ Z\end{matrix} ] = [ \begin{matrix}{X}_{r , max} & {X}_{g , max} & {X}_{b , max} \\ {Y}_{r , max} & {Y}_{g , max} & {Y}_{b , max} \\ {Z}_{r , max} & {Z}_{g , max} & {Z}_{b , max}\end{matrix} ] [ \begin{matrix}R \\ G \\ B\end{matrix} ]$$

$$where$$

$$R = \{ \begin{matrix}{[ ( {d}_{r} - {k}_{o , r} ) / ( 1.0 - {k}_{o , r} ) ]}^{{γ}_{r}} , & [ ( {d}_{r} - {k}_{o , r} ) / ( 1.0 - {k}_{o , r} ) ] \geq 0 \\ 0 & [ ( {d}_{r} - {k}_{o , r} ) / ( 1.0 - {k}_{o , r} ) ] < 0\end{matrix} \}$$

$$G = \{ \begin{matrix}{[ ( {d}_{g} - {k}_{o , g} ) / ( 1.0 - {k}_{o , g} ) ]}^{{γ}_{g}} , & [ ( {d}_{g} - {k}_{o , g} ) / ( 1.0 - {k}_{o , g} ) ] \geq 0 \\ 0 & [ ( {d}_{g} - {k}_{o , g} ) / ( 1.0 - {k}_{o , g} ) ] < 0\end{matrix} \}$$

$$B = \{ \begin{matrix}{[ ( {d}_{b} - {k}_{o , b} ) / ( 1.0 - {k}_{o , b} ) ]}^{{γ}_{b}} , & [ ( {d}_{b} - {k}_{o , b} ) / ( 1.0 - {k}_{o , b} ) ] \geq 0 \\ 0 & [ ( {d}_{b} - {k}_{o , b} ) / ( 1.0 - {k}_{o , b} ) ] < 0\end{matrix} \}$$

The variables dᵣ, d_{g}, and d_{b} are the digital input values normalized to 1.0. The parameters k_{o,r}, k_{o,g}, and k_{o,b}, are the blackpoints and the parameters γᵣ, γ_{g}, and γ_{b} are the gammas for the red, green, blue channels.

The values of parameters k_{o,r}, k_{o,g}, and k_{o,b}, are determined as follows: Assume that (regardless of the properties of a particular monitor) for the red channel there exists a minimal visible set of values for XYZ that can be detected by the human eye, designated as the vector (X_{t,r},Y_{t,r},Z_{t,r}). This vector will have a unique corresponding value for R in the expression above, designated as Rₜ. For a particular monitor with specific values of γᵣ and k_{o,r} there will be a unique device value associated with Rₜ which is designated by d_{t,r}:

$${R}_{t} = \{ \begin{matrix}{[ ( {d}_{t , r} - {k}_{o , r} ) / ( 1.0 - {k}_{o , r} ) ]}^{{γ}_{r}} , & [ ( {d}_{t , r} - {k}_{o , r} ) / ( 1.0 - {k}_{o , r} ) ] \geq 0 \\ 0 & [ ( {d}_{t , r} - {k}_{o , r} ) / ( 1.0 - {k}_{o , r} ) ] < 0\end{matrix} \}$$

This device value d_{t,r}, is determined by the user during the color profiling procedure as described, i.e., by selecting the darkest barely visible row of elements in the blackpoint determination web page for red. The value of Rₜ is empirically determined. For example, for a calibrated display system in a dark room with k_{o,r}=0.0 and γᵣ=2.2, a red patch may be visible for d_{t,r}=8/255 gray levels which implies Rₜ=(8/255)^{2.2}.

The exact value of k_{o,r} can be calculated by solving two simultaneous equations, namely the equation above for Rₜ and the equation for R_{0.33} which will be described below. Alternatively, a reasonable estimate can be made for k_{o,r} by assuming a gamma of 2.2. If this assumption is made, the value of k_{o,r} can be estimated as:

$${R}_{t} = {( \frac{8.0}{255.0} )}^{22} = {[ ( {d}_{t , r} - {k}_{o , r} ) / ( 1.0 - {k}_{o , r} ) ]}^{2.2}$$

$$( \frac{8.0}{255.0} ) = [ ( {d}_{t , r} - {k}_{o , r} ) / ( 1.0 - {k}_{o , r} ) ] \approx {d}_{t , r} - {k}_{o , r}$$

$${k}_{o , r} = {d}_{t , r} - ( \frac{8.0}{255.0} )$$

In a similar fashion, the values for k_{o,g} and k_{o,b}, can be determined.

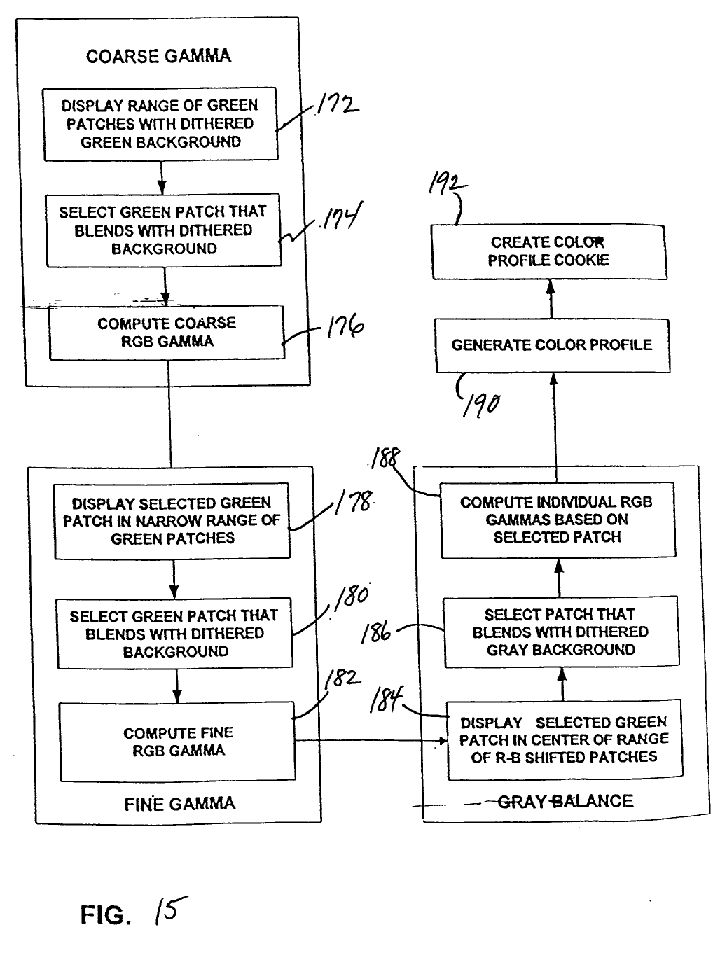

FIG. 15 is a flow diagram illustrating gamma and gray balance determination in a color profiling process. For determination of coarse gamma, one of the web pages served by color profile server 20 displays a range of green elements, e.g., patches, against a dithered green background (172). The coarse gamma determination web page can be served immediately and automatically following selection of a row of elements in the last blackpoint determination web page, or in response to selection of a “next” icon or similar device.

In one embodiment, the coarse gamma determination is limited to only the green color channel. Specifically, the coarse gamma determination is made using a series of green elements against a green dithered background. Green is the most dominant and intense phosphor among red, green, and blue, and is highest in contrast. Green also has the highest L*. Note also that green most closely matches the photopic V(λ) response of the eye. This approach to coarse gamma determination considers only the green color channel, and essentially ignores red and blue.

In this manner, the coarse gamma measurement concentrates on the most dominant color channel and avoids errors that can arise due to the red-blue imbalances that are highly prevalent in many display devices. Thus, the elements displayed for the coarse gamma determination may be green patches with different darkness or lightness values. Alternatively, a combined coarse gamma for all of the color channels may be determined as described in the above-referenced U.S. patent application Ser. No. 09/631,312.

Upon display of the green patches, the user is instructed to select a patch that appears to most closely blend with the dithered background (174). The green patch “blends” with the dithered background in the sense that it appears to closely match the level of the background. An example of a range of green patches displayed against a green dithered background is shown in FIG. 16 and indicated by reference numeral 173. This range of green patches and the green dithered background can be displayed in a web page served by color profile server 20. Based on the selected green patch, which again may be selected by clicking on it with a pointing device, color profile server 20 computes a coarse gamma (176). The coarse gamma determined in this step can be used as an estimate for the average gamma of R, G, and B via selection of a green patch from the set of green patches against the dithered green background. The dithered green background may be set at approximately 25% to 50%. Dithered backgrounds approaching approximately 33% may more closely match the actual midpoint of black to green transition for the display device, and may be preferred for typical display devices.

By alternating black and green at an appropriate frequency, a 25%, 33%, or 50% green background can be produced. For a CRT, turning on or off all of the pixels in a given horizontal line should produce more predictable output from display device to display device than modulating individual pixels to form vertical lines, due to the video bandwidth of the device. For flat panel devices, this is less of an issue. To accommodate clients using both CRT's and flat panel devices, however, generation of the dithered background by use of alternating horizontal lines is preferred.

The center patch in the range 173 of patches can be based on an average gamma of 2.0, since most monitors range from 1.6 to 2.5. The other green patches that surround the center patch may proceed in a sequence with relatively large steps, e.g., 8 gray levels apart from one another. Coarse gamma can be estimated using the equation:

G_{0.33}=0.333=[(d_{0.33,g}−k_{o,g})/(1.0−k_{o,g})]^{γ}^{_{g}}

where d_{0.33,g} is the gray level value (normalized to 1.0) of the selected patch that appears to most closely blend in with the background, k_{o,g} is the previously determined blackpoint, G_{0.33} is the relative intensity of the green channel (equal to ⅓) , and γ_{g} is the green gamma. As an alternative to actually computing the coarse gamma, the green level value of the selected patch simply is carried forward for use in the fine gamma process. In this case, the value can eventually be discarded.

After the coarse gamma estimate is obtained, fine gamma is estimated. Fine gamma is a refined or “fine-tuned” estimate for the average gamma of R, G, and B. Fine gamma can be determined by selection of another green patch from a set of green patches presented against a dithered green background. In this case, the center patch may be identical to the green patch selected by the user for determination of coarse gamma. Thus, the coarse gamma step “informs” the fine gamma step. In effect, the selected coarse gamma patch may serve as a starting point for the fine gamma determination. Specifically, the green patch selected in the coarse gamma determination can be used as the central patch for the fine gamma determination.

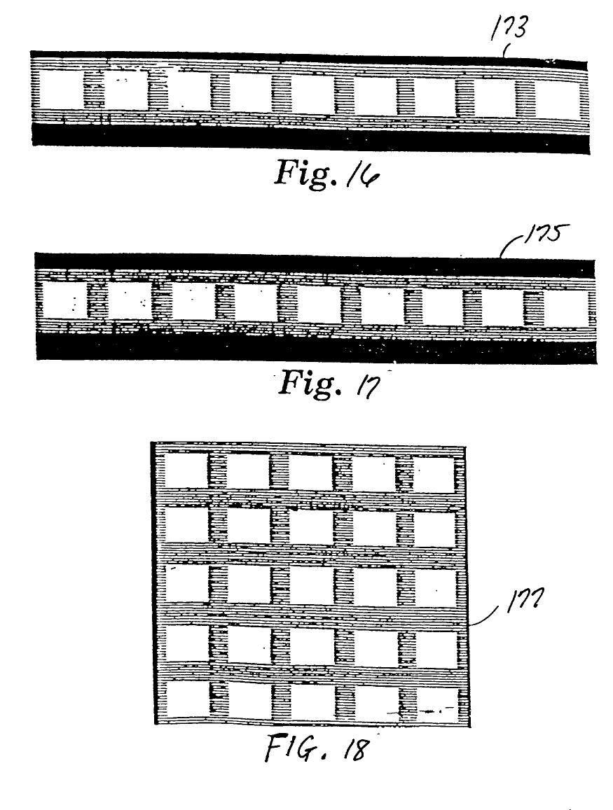

A range of patches for determining fine gamma is illustrated in FIG. 17 and designated by reference numeral 175. The patches in this range are in a sequence with smaller steps centered about the center green patch selected in the coarse gamma process. For example, the patches may be set at 4 green levels apart, in contrast to the 8 green levels used as the difference for the coarse gamma determination. In this manner, a narrower range is used to “fine-tune” the coarse gamma estimate, with the center of the range having been “learned” from the coarse gamma estimate.

A web page served by color profile server 20 displays the selected green patch from the coarse gamma estimate among a narrower range of green patches (178). The user then is instructed to select the green patch that most closely blends with the same dithered green background as used for the coarse gamma determination (180). Based on the selected green patch, color profile server 20 computes a single fine RGB gamma (182). Thus, the fine gamma is the overall gamma estimated for the RGB channels, but is derived from the green channel. Alternatively, as mentioned above, the RGB value of the selected patch can simply be stored for use by color image server 18 in computing fine gamma and rendering color corrections. In any event, a refined estimate for gamma can be computed according to the equation:

G_{0.33}=0.333=[(d_{0.33,g}−k_{o,g})/(1.0−k_{o,g})]^{γ}^{_{g}}

where d_{0.33,g} is the green level value (normalized to 1.0) of the selected patch that blends in with the background, k_{o,g} is the previously determined blackpoint, G_{0.33} is the relative intensity of the green channel (equal to ⅓), and γ_{g} is the green gamma.

To determine gray balance, color profile server 20 serves a web page that displays a plurality of RGB patches. The RGB patches can be generated with the same value of green selected in the previous fine gamma step in conjunction with values of red and blue that are substantially equal to or systematically shifted from the previously selected value of green. The RGB patches can be displayed against a gray background which is dithered in the same manner as the green dithered background of the previous step (fine gamma) (184). Again, this step “learns” from the previous one, and forms part of a cascading series of color profiling steps (coarse gamma, fine gamma, and gray balance) that help narrow the search for the correct gamma. The user is then instructed to select the gray patch that appears to most closely blend with the dithered background (186). Based on the selected gray patch, individual RGB gammas are computed (188). Notably, the overall gray balance determination can be made with a single click of the user's pointing device.

Thus, in this gray balance process, the green intensity value selected in the fine gamma process is used to generate the gray patches that exhibit +/− (plus/minus) differences or “shifts” in red and blue about the value of a central gray patch with RGB values determined according to the gamma estimate from the fine gamma process. For example, the value of green selected in the fine gamma process can be displayed in the center of the range in conjunction with substantially identical values of red and blue. The gammas for red and blue are then fine tuned by the gray balance determination, which helps identify red-blue imbalance in the display device. Thus, the green gamma is “locked in” in the gray balance step, while the red and blue imbalance is determined. In other words, every patch in the gray balance array carries the same green value, but is modulated by different gradations of red and blue. This step eliminates one axis of variation, green, but permits identification of any imbalance between red and green or blue and green. This limits the range of choices to a more finely-tuned area, and aids the user in making a more accurate selection.

The range of patches for the gray balance determination may be a two-dimensional array of patches with red-blue-shifted patches arranged around the central gray patch generated according to the gamma estimate from the fine gamma process. In other embodiments, the red channel could be used to determine the initial RGB gamma estimate, followed by a gray balance determination that resolves imbalance between green and red or blue and red.

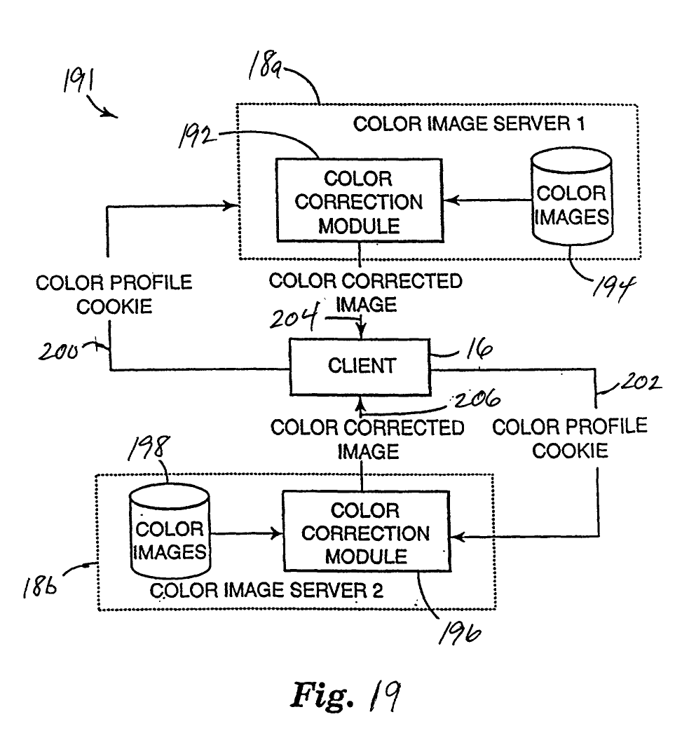

FIG. 18 illustrates an example of a two-dimensional range 177 of gray patches arranged in a five-by-five matrix for use in the gray balance determination. Each patch represents a shift away from the central gray patch along either the blue axis, the red axis, or a combination of both, but preferably does not represent any further green shift. The user selects the patch that appears to most closely blend with the dithered gray background, which may be a 33% dithered background. The central patch can optionally be highlighted to indicate it is the preferred default choice.

The number of patches and the exact values of RGB for each patch can be quite flexible. For example, in the case of the image in FIG. 18, all patches can be selected to have identical values of L* as indicated by the estimated profile for the display based on phosphors, average gamma, and blackpoint. Patches adjacent to the center may differ by all permutations of +/−3 ΔE for a* and for b* as estimated from a Matrix TRC (tone reproduction curve) profile constructed from the above parameters.

Patches around the outer perimeter of the grid array may differ from the center by +/− 6 ΔE in R and B. Alternatively, for simplicity, one can elect to vary R and B only by +/− a fixed amount such as +/− 5 gray levels and +/− 10 gray levels. Preferably, all patches are relatively small deviations from the central patch in all directions of color space of approximately constant L*. This test will help determine in a sensitive manner whether there exists a significant difference in the gammas of R, G, and B, and thereby expose significant gray imbalance between R and B.

The two-dimensional format of the patches shown in FIG. 18 may aid the user's selection of the correct patch. The patch from the previous step in the color profiling process, i.e., fine gamma, is placed at the center in this embodiment. Adjacent patches differ in gray level as the array extends outward such that the outer periphery of the array contains patches that are two gradations removed from the central patch. The array produces a visual “funnel” effect that, from experience, tends to direct the user toward the central patch as the starting point for matching with the background. The differences between patches in the two-dimensional array are more clear and dramatic than in a one-dimensional strip of patches. As the array extends outward, the shift becomes greater. Thus, the gradations are well pronounced and aid the user in picking the appropriate patch which, in many cases, will be the central patch selected in the previous step of the color profiling process.

If the user selects the central patch, a single gamma value is used for the R, G, and B channels. If one of the other patches are selected, three separate gammas are calculated based on the equations:

R_{0.33}=0.333=[(d_{0.33,r}−k_{o,r})/(1.0−k_{o,r})]^{γ}^{ᵣ}

B_{0.33}=0.333=[(d_{0.33,b}−k_{o,b})/(1.0−k_{o,b})]^{γ}^{_{b}}

where the subscripts for γ and d_{0.33} indicate unique values for the R and B channels. The values for d_{0.33} for each channel are given by the values of RGB of the particular patch selected in this gray balance step. These equations are combined with a set of phosphor values to generate accurate profiles for the client's display device, using equations well known in the art, and referred to as Matrix TRC formalism in the International Color Consortium (ICC) specification. Again, calculations can be performed by color profile server 20 or by a color correction module associated with color image servers 18.

The process of selecting patches in the coarse gamma, fine gamma, and gray balance determination steps is advantageous because, in preferred embodiments, it requires no applications, applets, or other client-side scripts to be loaded at the client side. Rather, the user may simply select one of the patches displayed in a web page. In other embodiments, however, if applications, applets, or client-side scripts are used, it is conceivable that smooth slider bars, +/− arrows, and the like could be used to adjust the color of a single patch in real-time for comparison to the dithered background. In this manner, the user has the ability to precisely match a single patch to the background, rather than select from a finite set of patches the one that most closely matches. This technique of real-time adjustment also may be useful for non-networked approaches to color calibration and characterization. In this case, for blackpoints, gamma, and/or gray balance, the patch or element selected by the user may be a single adjustable patch in a condition in which the slider or other adjustment medium has adjusted its color to a level that is visually acceptable to the user, i.e., to a point at which the patch appears to match the dithered background.

Based on the blackpoint, coarse gamma, fine gamma, and gray balance processes, a color profile for the display device is generated (190). Upon generation of the color profile, a color profiler cookie is created (192). Information representative of the color profile is added to the color profiler cookie for future use. In particular, the information can be used to create an image server cookie for future interaction between the particular client 14, 16 and the particular network server 12 and color image server 18. Although the color profile is especially useful for characterizing display devices in a network, it also may be useful in a non-networked application. In particular, the color profiling process described herein may find ready use in the calibration and characterization of an individual display device for correction of content generated or obtained locally with the device, rather than across a network.

Advantageously, there is no need for the client 14, 16 to provide information regarding the configuration of its display device. Very satisfactory results can occur using an average set of phosphor values based on published standards such as sRGB, Apple Macintosh RGB, and the like. If desired, further steps can be added, particularly in order to address the issue of phosphor values and white point. The color profiling process simply results in generation of a cookie that serves as a container and vehicle for passing information characterizing the color response of the display device associated with client 14a-14n to color image server 18. Alternatively, the chromaticity information and white point can in some cases be obtained from the display utilizing communication protocols such as VESA and/or from the operating system of the computer. The usefulness of this invention will continue because, with current technology, the RGB blackpoints and gammas are difficult to maintain perfectly at the hardware level even with expensive electronic circuitry.

Ordinarily, all cookies visible to a particular domain are attached to each request from a browser application executed by a client 14, 16. For this reason, a typical browser limits each domain to a maximum of twenty cookies. To avoid consuming the allotment of cookies for a particular web site, all of the color correction information for a particular client 14, 16 preferably is packed into a single profiler cookie and a single image server cookie. For example, a number of items can be packed into the value string of the image server cookie or the profiler cookie, as the case may be. In particular, each cookie should include the gamma values for R, G, and B. Each gamma value may be a value between 1.0 and about 3.0. In addition, the cookie may include the chromaticity values for black and white, e.g., expressed as a value between 0 and +1000.0.

An exemplary cookie may have the following items packed into its value string, each demarcated by a separator:

(1) Cookie format version code—a numeric code, e.g., 1 to 3 bytes, plus separator.

(2) Cookie installation date—the usual cookie-style timestamp (milliseconds after midnight of Jan. 1, 1970, GMT), e.g., 12 to 13 bytes, plus separator.

(3) Unique profiler ID assigned to this color information when it is generated by the color correction sequence; a long integer, e.g., 4 bytes, plus separator (but possibly longer).

(4) Gamma and blackpoint values for R, G, B—each a text representation of a floating-point value between 1.0 and about 3.0, retaining 4 decimal digits. The decimal point could be implied. Thus, the gamma values may take up 5 or 6 bytes plus a separator each, or three times that overall. Alternatively, the selected tint values chosen for R, G, and B can be indicated, enabling the gamma and blackpoint values to be calculated at a later time by a server upon upload of the cookie.

(5) Chromaticity for Black and White—each a text representation of a floating-point value between 0 and +1000.0, retaining 4 significant digits. Thus, this may take up 6 or 7 bytes plus a separator each, or two times that overall.

(6) Number of bits per color—two decimal digits: two bytes plus separator.

(7) Display Device ID code—an alphanumeric code, which may be roughly 10 bytes plus separator.

(8) Cookie Data Checksum—a long integer: 4 bytes.

The example cookie described above has about 68 bytes plus 10 separators. The separator character should be chosen so that the string does not have to be “escaped”; the caret (ˆ ) is frequently used this way. Thus, the typical size for the value string may be about 80 bytes.

FIG. 19 is block diagram illustrating transmission of color correction information in a system as shown in FIGS. 1 and 2. In particular, FIG. 19 illustrates a system 191 in which image server cookies have already been created for two different color image servers 18a, 18b accessed by an individual destination client 16. In this case, upon accessing a web page from a network server 12, destination client 16 requests images from color image server 18a. When requesting images from another network server 12, destination client 16 requests images from color image server 18b. Color image server 18a incorporates both a color correction module 192 and an archive 194 of color images. Similarly, color image server 18b includes a color correction module 196 and an archive 198 of color images.

When destination client 16 sends an image request to color image server 18a, it sends along a destination profile cookie, i.e., an image server cookie, as indicated by line 200. Likewise, as indicated by line 202, destination client 16 sends an image server cookie to color image server 18b when requesting an image. In each case, the image server cookie contains a color profile that provides color correction information for use by the respective color correction module 192, 196 in modifying, i.e., color correcting, the color images served from image archives 194, 198, respectively. Thus, when a request is received, color images server 18a or 18b processes the accompanying image server cookie to extract the contents, and controls the respective color correction module 192, 196 based on the extracted contents. In this manner, destination client 16 receives color corrected images, as indicated by reference numerals 204, 206.

The manner in which color correction modules make use of the color profiles contained in the image server cookies will now be described. In the embodiment described with reference to FIGS. 12-19, blackpoints for each color channel are estimated based on red, green, and blue elements selected by a user associated with a respective source client 14 or destination client 16. Thus, the output of the color profiling process is a blackpoint RGB value and a gamma, or individual RGB gammas. Now we assume that these values have been determined in the manner described above. The complete description of the display device behavior can be given by the following equation which relates RGB−>XYZ:

$$[ \begin{matrix}X \\ Y \\ Z\end{matrix} ] = [ \begin{matrix}{X}_{r , max} & {X}_{g , max} & {X}_{b , max} \\ {Y}_{r , max} & {Y}_{g , max} & {Y}_{b , max} \\ {Z}_{r , max} & {Z}_{g , max} & {Z}_{b , max}\end{matrix} ] [ \begin{matrix}R \\ G \\ B\end{matrix} ]$$

$$where$$

$$R = \{ \begin{matrix}{[ ( {d}_{r} - {k}_{o , r} ) / ( 1.0 - {k}_{o , r} ) ]}^{{γ}_{r}} , & [ ( {d}_{r} - {k}_{o , r} ) / ( 1.0 - {k}_{o , r} ) ] \geq 0 \\ 0 & [ ( {d}_{r} - {k}_{o , r} ) / ( 1.0 - {k}_{o , r} ) ] < 0\end{matrix} \}$$

$$G = \{ \begin{matrix}{[ ( {d}_{g} - {k}_{o , g} ) / ( 1.0 - {k}_{o , g} ) ]}^{{γ}_{g}} , & [ ( {d}_{g} - {k}_{o , g} ) / ( 1.0 - {k}_{o , g} ) ] \geq 0 \\ 0 & [ ( {d}_{g} - {k}_{o , g} ) / ( 1.0 - {k}_{o , g} ) ] < 0\end{matrix} \}$$

$$B = \{ \begin{matrix}{[ ( {d}_{b} - {k}_{o , b} ) / ( 1.0 - {k}_{o , b} ) ]}^{{γ}_{b}} , & [ ( {d}_{b} - {k}_{o , b} ) / ( 1.0 - {k}_{o , b} ) ] \geq 0 \\ 0 & [ ( {d}_{b} - {k}_{o , b} ) / ( 1.0 - {k}_{o , b} ) ] < 0\end{matrix} \}$$

The variables dᵣ, d_{g}, and d_{b} are the digital input values for the red, green, and blue channels normalized to 1.0. The parameters k_{o,r}, k_{o,g}, and k_{o,b}, are the blackpoints for the red, green, and blue channels, and the parameters γᵣ, γ_{g}, and γ_{b} are the gammas for the red, green, blue channels. Thus, the gamma and blackpoint information contained in the image server cookie for a respective display device can be used in the above equations to produce, in effect, a destination device profile. The destination device profile, with a source profile previously computed for the requested image, can be used to perform a transformation of the image data sufficient to produce calibrated output on the display device.

The above approach is different than other attempts to characterize display devices such as equation 21 in Berns, “CRT Colorimetry. Part I: Theory and Practice.” In most characterizations, the “k” parameters are used to describe black offset rather than blackpoint. Black offset refers to the non-zero intensity measured or perceived from a display for RGB=0. In our experience, the contrast/brightness adjustment procedure used in a color profiling process in accordance with embodiments of this invention minimizes the effect of this phenomenon. However, non-zero blackpoints are very possible even after the contrast/brightness adjustment, and therefore should be taken into account.

This profile description can either be used in this format or converted to formats such as those specified by the ICC. This format is also known as the Matrix TRC format, and utilizes a generic lookup table for the expressions above for R, G, and B rather than an equation combined with a matrix similar to above. The above information, e.g., gammas, blackpoints, and the like, can be stored in a cookie on a computer associated with a client 14, 16. Alternatively, the individual data which are the RGB values of the patches selected by the user can be stored in the cookie, which can permit improved profile technology to be employed at a later date utilizing the same input information.

To implement a system as described herein with an existing archive of images and HTML codebase for a web site, the existing network server 12 is modified to replace existing image file references indicated in HTML pages with similar references to a pertinent color image server 18 equipped with a color correction module. For example, an existing subscriber image file reference called:

http://SubscriberName.com/images/ImageName.jpg

could be replaced with:

http://correction.SubscriberName.com/images/ImageName.jpg.

These modified references in the HTML page then issue a command to the color image server 18 to serve the requested image. When the color image server 18 receives the command, it also receives the image server cookie, if one exists, and applies the information contained in the cookie to perform color correction. The color image server 18 then reads the pertinent image file, creates a unique display profile utilizing the display parameters stored in the image server cookie, and converts the image from source to destination before sending it to the client's browser.

All images stored on the network server 12 may have a corresponding copy file of the same name residing on the subscriber color image server 18. The color image server 18 may access this database of image files to read, convert, and send images referenced by the HTML page sent to the client 14, 16. According to one embodiment, color image server 18 may use a very simple and quick technique for color management. In particular, all images on the color image server 18 preferably have a predetermined RGB color space. This typically means that original images are converted from the color space of corresponding source devices, e.g., such as scanners, digital cameras, and the like, to the standard color space determined by a particular web site. Good examples of standard RGB color spaces are ColorMatch RGB, which has a color temperature for the “virtual display” of D50. Other color spaces such as Adobe RGB have an excellent gamut, but have a color temperature of D65. When an image on an HTML page sent to the client 14, 16 is referenced via the color image server 18 associated with a network server 12 such as:

correction.SubscriberName.com/images/ImageName.jpg

color image server 18 accesses the corresponding image and converts the RGB data in real time before sending the image to the client destination. The conversion can be performed according to the following calculation:

$${R}_{s} = \{ \begin{matrix}{[ ( {d}_{r , s} - {k}_{o , r , s} ) / ( 1.0 - {k}_{o , r , s} ) ]}^{{γ}_{r , s}} , & [ ( {d}_{r , s} - {k}_{o , r , s} ) / ( 1.0 - {k}_{o , r , s} ) ] \geq 0 \\ 0 & [ ( {d}_{r , s} - {k}_{o , r , s} ) / ( 1.0 - {k}_{o , r , s} ) ] < 0\end{matrix} \}$$

$${G}_{s} = \{ \begin{matrix}{[ ( {d}_{g , s} - {k}_{o , g , s} ) / ( 1.0 - {k}_{o , g , s} ) ]}^{{γ}_{g , s}} , & [ ( {d}_{g , s} - {k}_{o , g , s} ) / ( 1.0 - {k}_{o , g , s} ) ] \geq 0 \\ 0 & [ ( {d}_{g , s} - {k}_{o , g , s} ) / ( 1.0 - {k}_{o , g , s} ) ] < 0\end{matrix} \}$$

$${B}_{s} = \{ \begin{matrix}{[ ( {d}_{b , s} - {k}_{o , b , s} ) / ( 1.0 - {k}_{o , b , s} ) ]}^{{γ}_{b , s}} , & [ ( {d}_{b , s} - {k}_{o , b , s} ) / ( 1.0 - {k}_{o , b , s} ) ] \geq 0 \\ 0 & [ ( {d}_{b , s} - {k}_{o , b , s} ) / ( 1.0 - {k}_{o , b , s} ) ] < 0\end{matrix} \} \\ [ \begin{matrix}{R}_{c} \\ {G}_{c} \\ {B}_{c}\end{matrix} ] = {[ \begin{matrix}{X}_{r , c , max} & {X}_{g , c , max} & {X}_{b , c , max} \\ {Y}_{r , c , max} & {Y}_{g , c , max} & {Y}_{b , c , max} \\ {Z}_{r , c , max} & {Z}_{g , c , max} & {Z}_{b , c , max}\end{matrix} ]}^{- 1} [ \begin{matrix}{X}_{r , s , max} & {X}_{g , s , max} & {X}_{b , s , max} \\ {Y}_{r , s , max} & {Y}_{g , s , max} & {Y}_{b , s , max} \\ {Z}_{r , s , max} & {Z}_{g , s , max} & {Z}_{b , s , max}\end{matrix} ] [ \begin{matrix}{R}_{s} \\ {G}_{s} \\ {B}_{s}\end{matrix} ]$$

$${d}_{r , c} = {k}_{o , r , c} + ( 1.0 - {k}_{o , r , c} ) {min ( 1.0 , {R}_{c} )}^{1 / {γ}_{r , c}}$$

$${d}_{g , c} = {k}_{o , g , c} + ( 1.0 - {k}_{o , g , c} ) {min ( 1.0 , {G}_{c} )}^{1 / {γ}_{g , c}}$$

$${d}_{b , c} = {k}_{o , b , c} + ( 1.0 - {k}_{o , b , c} ) {min ( 1.0 , {B}_{c} )}^{1 / {γ}_{b , c}}$$

Note that the matrices above can be concatenated into a single matrix for increased processing speed.

As an alternative architecture, all images for various web sites may be stored at a central color image server 18. Color profiling server 20 may reside or be integrated with color image server 18 in such an embodiment. In this case, color profiling server 18 provides web pages for guidance of a color profiling process as described herein. Color image server 18 or color profile server 20 may include a database server for storage of individual color profiles associated with source and destination clients 14, 16. When a client 14, 16 requests an image tagged in the code sent by one of network servers 12, it is directed to the central color image server 18. The color image server 18 may use a client ID sent from the client to retrieve the appropriate color profile and apply it to modify the requested color image using techniques as described herein for color correction. In this manner, color image server 18 provides color corrected images without the need for transfer of cookies and the like between clients 14, 16 and the color image server.

A number of embodiments of the present invention have been described. Nevertheless, it will be understood that various modifications may be made without departing from the spirit and scope of the invention. Accordingly, other embodiments are within the scope of the following claims.

1. A method comprising:
receiving color images from source clients via a computer network;
communicating the color images to destination clients via the computer network; and
modifying the color images based on the calorimetric responses of display devices associated with the source clients.

2. The method of claim 1, further comprising modifying the color images based on the colorimetric responses of display devices associated with the destination clients.

3. The method of claim 1, further comprising modifying the color images at a network server, wherein the network server includes a web server, and the images are accessible via a web site served by the web server.

4. The method of claim 1, further comprising modifying the color images at a network server before communication of the color images to the destination clients.

5. The method of claim 1, wherein the source clients include auction sellers, the images represent auction items, and the destination clients include auction buyers.

6. The method of claim 1, wherein the source clients include photographers, and the images represent photographs taken by the photographers.

7. The method of claim 1, further comprising characterizing the colorimetric responses of the display devices by delivering a series of web pages to the client that guide the clients through a color profiling process.

8. The method of claim 7, further comprising:
guiding the clients through the color profiling process by delivering a series of web pages to the clients;
generating web cookies for the clients containing information representing the results of the color profiling process; and
transmitting the web cookies to a network server for use in the modification of the color images.

9. The method of claim 8, wherein the network server modifies the color images based on the contents of the web cookie.

10. The method of claim 1, wherein the network server resides on the World Wide Web, and the color images form parts of web pages received by the clients from the network server.

11. The method of claim 1, further comprising calculating a fee for each modified image.

12. The method of claim 11, further comprising:
permitting the source clients to specify whether the color images are to be modified;
charging the fee to the source clients in the event modification of the color images is specified.

13. The method of claim 11, further comprising:
permitting the destination clients to specify whether the color images are to be modified;
charging the fee only in the event modification of the color images is specified.

14. The method of claim 1, wherein the source clients are auction sellers, the images represent auction items, and the destination clients are auction buyers, the method further comprising calculating a fee for each modified image, and charging the fee to one or both of the source and destination clients involved in an auction sale.

15. The method of claim 1, wherein the source clients include auction sellers, the images represent auction items, and the destination clients include auction buyers, the method further comprising calculating, for each modified image, a fee based on a percentage of the sales amount paid between source and destination clients involved in an auction sale, and charging the fee to one or both of the source and destination clients involved in the auction sale.

16. A computer readable medium containing program code that causes a programmable processor to:
receive color images from source clients via a computer network;
communicate the color images to destination clients via the computer network; and
modify the color images based on the colorimetric responses of display devices associated with the source clients.

17. The computer-readable medium of claim 16, wherein the code causes the processor to modify the color images based on the calorimetric responses of display devices associated with the destination clients.

18. The computer readable medium of claim 16, further comprising a network server, wherein the images are accessible via a web site served by the network server.

19. The computer readable medium of claim 16, wherein the code causes the processor to modify the color images at a network server before communication of the color images to the destination clients.

20. The computer readable medium of claim 16, wherein the source clients are auction sellers, the images represent auction items, and the destination clients are auction buyers.

21. The computer readable medium of claim 16, wherein the source clients are photographers, and the images represent photographs taken by the photographers.

22. The computer readable medium of claim 16, wherein the code causes the processor to characterize the calorimetric responses of the display devices by guiding the clients through a color profiling process.

23. The computer readable medium of claim 22, wherein the code causes the processor to guide the client through the color profiling process by delivering a series of web pages to the client.

24. The computer readable medium of claim 22, wherein the color profiling process includes estimating a gamma for each of the display devices.

25. The computer readable medium of claim 22, wherein the code causes the processor to:
guide the clients through the color profiling process by delivering a series of web pages to the clients;
generate web cookies for the clients containing information representing the results of the color profiling process; and
transmit the web cookies to a network server for use in the modification of the color images.

26. The computer readable medium of claim 22, wherein the code causes the processor to control a network server that modifies the color images based on the contents of the web cookie.

27. The computer readable medium of claim 26, wherein the network server includes a color server that modifies the color images based on the contents of the web cookies.

28. The computer readable medium of claim 27, wherein the network server resides on the World Wide Web, and the color images form parts of web pages received by the clients from the network server.

29. The computer readable medium of claim 22, wherein the code causes the processor to calculate a fee for each modified image.

30. The computer readable medium of claim 29, wherein the code causes the processor to:
permit the source clients to specify whether the color images are to be modified;
charge the fee to the source clients in the event modification of the color images is specified.

31. The computer readable medium of claim 22, wherein the source clients are auction sellers, the images represent auction items, and the destination clients are auction buyers, and the code causes the processor to calculate a fee for each modified image, and charge the fee to one or both of the source and destination clients involved in an auction sale.

32. The computer readable medium of claim 31, wherein the code causes the processor to:
permit the source clients to specify whether the color images are to be modified;
charging the fee only in the event modification of the color images is specified.

33. The computer readable medium of claim 31, wherein the code causes the processor to:
permit the destination clients to specify whether the color images are to be modified;
charging the fee only in the event modification of the color images is specified.

34. The computer readable medium of claim 22, wherein the source clients are auction sellers, the images represent auction items, and the destination clients are auction buyers, and the code causes the processor to calculate, for each modified image, a fee based on a percentage of the sales amount paid between source and destination clients involved in an auction sale, and charge the fee to one or both of the source and destination clients involved in the auction sale.

35. The computer readable medium of claim 22, wherein the program code is contained both in physical data storage media and signals transmitted between the client and other resources on the computer network.

36. A system comprising:
a network server that receives color images from source clients and communicates the color images to destination clients; and
a color image server that modifies the color images based on the colorimetric responses of display devices associated with the source clients.

37. The system of claim 36, wherein the color image server modifies the color images based on the calorimetric responses of display devices associated with the destination clients.

38. The system of claim 36, wherein the network server includes a network server, and the images are accessible via a web site served by the network server.

39. The system of claim 36, wherein the network server modifies the color images before communication of the color images to the destination clients.

40. The system of claim 36, wherein the source clients include auction sellers, the images represent auction items, and the destination clients include auction buyers.

41. The system of claim 36, wherein the source clients include photographers, and the images represent photographs taken by the photographers.

42. The system of claim 36, further comprising a color profile server that guides the source and destination clients through a color profiling process to obtain information characterizing the colorimetric responses of the display devices associated with the clients.

43. The system of claim 42, wherein the color profile server guides the source and destination clients through the color profiling process by delivering a series of web pages to the client.

44. The system of claim 42, wherein the color profiling server guides the clients through the color profiling process by delivering a series of web pages to the clients, and generates web cookies for the clients containing information representing the results of the color profiling process, the clients transmitting the web cookies to the network server.

45. The system of claim 44, wherein the network server modifies the color images based on the contents of the web cookie.

46. The system of claim 44, wherein the network server resides on the World Wide Web, and the color images form parts of web pages received by the clients from the network server.

47. The system of claim 36, further comprising a fee calculation module that calculates a fee for each modified image.

48. The system of claim 47, wherein the fee calculation module charges the fee to the source clients in the event modification of the color images is specified.

49. The system of claim 36, wherein the source clients are auction sellers, the images represent auction items, and the destination clients are auction buyers, the system further comprising a fee calculation module that calculates a fee for each modified image, and charges the fee to one or both of the source and destination clients involved in an auction sale.

50. The system of claim 36, wherein the source clients are auction sellers, the images represent auction items, and the destination clients are auction buyers, the system further comprising a fee calculation module that calculates, for each modified image, a fee based on a percentage of the sales amount paid between source and destination clients involved in an auction sale, and charges the fee to one or both of the source and destination clients involved in the auction sale.
